(19) United States
(12) Patent Application Publication
(10) Pub. No.: US 2006/0173628 A1
(43) Pub. Date: Aug. 3, 2006

(54) Method and system for determining feature-coordinate grid or subgrids of microarray images

(76) Inventors: Nicholas M. Sampas, San Jose, CA (US); Christian A. LeCocq, Menlo Park, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/049,182

(22) Filed: Feb. 2, 2005

(51) Int. Cl. G06F 19/00; G06K 9/00

(52) U.S. Cl. 702/19; 382/128

(57) ABSTRACT

The present invention provides various embodiments that are directed to methods and systems for determining a feature-coordinate grid of a microarray image so that individual features can be located and isolated for statistical analysis. The method receives microarray-image data and determines centroid coordinates for each feature of the microarray image. The methods and systems of the present invention determines uses the centroid coordinates to determine horizontal grid lines and vertical grid lines that are superimposed on the microarray image so that intersections of the grid lines coincide with features of the microarray image. The horizontal grid lines and vertical grid lines provide grid lines of the feature-coordinate grid.

Embodiments of the present invention are related to microarrays, and, in particular, to a method and system for determining a feature-coordinate grid or subgrid in order to assign a coordinate-based location to each feature of a microarray image or data set.

### BACKGROUND OF THE INVENTION

The present invention is related to microarrays. In order to facilitate discussion of the present invention, a general background for particular types of microarrays is provided below. In the following discussion the terms “microarray,” “molecular array,” and “array” are used interchangeably. The terms “microarray” and “molecular array” are well known and well understood in the scientific community. As discussed below, a microarray is a precisely manufactured tool which may be used in research, diagnostic testing, or various other analytical techniques to analyze complex solutions of any type of molecule that can be optically or radiometrically detected and that can bind with high specificity to complementary molecules synthesized within, or bound to, discrete features on the surface of a microarray. Because microarrays are widely used for analysis of nucleic acid samples, the following background information on microarrays is introduced in the context of analysis of nucleic acid solutions following a brief background of nucleic acid chemistry.

Deoxyribonucleic acid (“DNA”) and ribonucleic acid (“RNA”) are linear polymers, each synthesized from four different types of subunit molecules. FIG. 1 illustrates a short DNA polymer 100, called an oligomer, composed of the following subunits: (1) deoxy-adenosine 102; (2) deoxy-thymidine 104; (3) deoxy-cytosine 106; and (4) deoxy-guanosine 108. Phosphorylated subunits of DNA and RNA molecules called “nucleotides” are linked together through phosphodiester bonds 110-115 to form DNA and RNA polymers. A linear DNA molecule, such as the oligomer shown in FIG. 1, has a 5′ end 118 and a 3′ end 120. A DNA polymer can be chemically characterized by writing, in sequence from the 5′ end to the 3′ end, the single letter abbreviations A, T, C, and G for the nucleotide subunits that together compose the DNA polymer. For example, the oligomer 100 shown in FIG. 1 can be chemically represented as “ATCG.”

The DNA polymers that contain the organization information for living organisms occur in the nuclei of cells in pairs, forming double-stranded DNA helices. One polymer of the pair is laid out in a 5′ to 3′ direction, and the other polymer of the pair is laid out in a 3′ to 5′ direction or, in other words, the two strands are anti-parallel. The two DNA polymers, or strands, within a double-stranded DNA helix are bound to each other through attractive forces, including hydrophobic interactions between stacked purine and pyrimidine bases and hydrogen bonding between purine and pyrimidine bases, the attractive forces emphasized by conformational constraints of DNA polymers. FIGS. 2A-B illustrate the hydrogen bonding between the purine and pyrimidine bases of two anti-parallel DNA strands. AT and GC base pairs, illustrated in FIGS. 2A-B, are known as Watson-Crick (“WC”) base pairs. Two DNA strands linked together by hydrogen bonds form the familiar helix structure of a double-stranded DNA helix. FIG. 3 illustrates a short section of a DNA double helix 300 comprising a first strand 302 and a second, anti-parallel strand 304.

Double-stranded DNA may be denatured, or converted into single stranded DNA, by changing the ionic strength of the solution containing the double-stranded DNA or by raising the temperature of the solution. Single-stranded DNA polymers may be renatured, or converted back into DNA duplexes, by reversing the denaturing conditions; for example, by lowering the temperature of the solution containing complementary, single-stranded DNA polymers. During renaturing or hybridization, complementary bases of anti-parallel DNA strands form WC base pairs in a cooperative fashion, leading to reannealing of the DNA duplex.

FIGS. 4-7 illustrate the principle of the microarray-based hybridization assay. A microarray (402 in FIG. 4) comprises a substrate upon which a regular pattern of features is prepared by various manufacturing processes. The microarray 402 in FIG. 4, and in subsequent FIGS. 5-7, has a grid-like two-dimensional pattern of square features, such as feature 404 shown in the upper left-hand corner of the microarray. Each feature of the microarray contains a large number of identical oligonucleotides covalently bound to the surface of the feature. These bound oligonucleotides are known as probes. In general, chemically distinct probes are bound to the different features of a microarray so that each feature corresponds to a particular nucleotide sequence.

Once a microarray has been prepared, the microarray may be exposed to a sample solution of target DNA or RNA molecules (410-413 in FIG. 4) labeled with fluorophores, chemiluminescent compounds, or radioactive atoms 415-418. Labeled target DNA or RNA hybridizes through base pairing interactions to the complementary probe DNA synthesized on the surface of the microarray. FIG. 5 shows a number of such target molecules 502-504 hybridized to complementary probes 505-507, which are in turn bound to the surface of the microarray 402. Targets, such as labeled DNA molecules 508 and 509, that do not contain nucleotide sequences complementary to any of the probes bound to the microarray surface do not hybridize to generate stable duplexes and, as a result, tend to remain in solution. The sample solution is then rinsed from the surface of the microarray, washing away any unbound, labeled DNA molecules. In other embodiments, unlabeled target sample is allowed to hybridize with the microarray first. Typically, such a target sample has been modified with a chemical moiety that will react with a second chemical moiety in subsequent steps. Then, either before or after a wash step, a solution containing the second chemical moiety bound to a label is reacted with the target on the microarray. After washing the microarray is ready for analysis. Biotin and avidin represent an example of a pair of chemical moieties that can be utilized for such steps.

Finally, as shown in FIG. 6, the bound labeled DNA molecules are detected via optical or radiometric instrumental detection. Optical detection involves exciting labels of bound labeled DNA molecules with electromagnetic radiation of appropriate frequency and detecting fluorescent emissions from the labels or detecting light emitted from chemiluminescent labels. When radioisotope labels are employed, radiometric detection can be used to detect the signal emitted from the hybridized features. Additional types of signals are also possible, including electrical signals generated by electrical properties of bound target molecules, magnetic properties of bound target molecules, and other such physical properties of bound target molecules that can produce a detectable signal. Optical, radiometric, or other types of instrumental detection produce an analog or digital representation of the microarray as shown in FIG. 7, with features to which labeled target molecules are hybridized similar to 702 optically or digitally differentiated from those features to which no labeled DNA molecules are bound. Features displaying positive signals in the analog or digital representation indicate the presence of DNA molecules with complementary nucleotide sequences in the original sample solution. Moreover, the signal intensity produced by a feature is generally related to the amount of labeled DNA bound to the feature, in turn related to the concentration in the sample to which the microarray was exposed, of labeled DNA complementary to the oligonucleotide within the feature.

Microarray images are analyzed by reducing the optically-detected chemical-signal information for each feature into a set of statistical values. In order to determine the statistical information associated with each feature, each feature must be spatially isolated for statistical analysis. Spatially isolating a feature involves determining a feature-coordinate grid that specifies the location of each feature. However, determining the feature-coordinate grid may be complicated by image artifacts, such as noise and background signals, misalignment of rows and columns of features with the microarray-image edges, and irregularly spaced features on the microarray surface. Manufacturers and designers of microarrays and microarray readers, as well as researchers and diagnosticians who use microarrays in experimental and commercial settings, have recognized the need for methods and systems that can be used to determine the feature-coordinate grid or subgrid of microarray features so that each feature can be located and isolated for statistical analysis.

### SUMMARY OF THE INVENTION

Various embodiments of the present invention are directed to methods for determining a feature-coordinate grid of a microarray image or data set so that individual features can be located and isolated for statistical analysis. The method receives a microarray-image data set and determines the centroid coordinates of each feature. Lines are fit to the centroid coordinates of features located along each edge of the microarray image. The method determines the four corner of a feature-coordinate grid based on the intersection coordinates of the fitted lines. Based on the four comers, horizontal grid lines and vertical grid lines are superimposed on the microarray image so that horizontal and vertical grid line intersections coincide with features of the microarray image.

In another embodiment, the invention provides a method for determining a feature-coordinate grid of a microarray image. The method receives microarray-image data and determines the centroid coordinates for each feature of the microarray image. Each centroid is projected onto a first projection line that extends from the pixel-coordinate origin at a first angle to a first pixel-coordinate axis to give a distribution of densely packed points located along the first projection line. The first angle between the first projection line and the first pixel-coordinate axis is optimized based on the contrast between the one or more clusters of densely packed points located along the projection line. Grid lines that extend perpendicular to the first projection line and emanate from the centers of the one or more clusters of densely packed points are superimposed on the microarray image. The method can be repeated for a second projection line extending from the pixel-coordinate origin at a second angle to a second pixel-coordinate axis.

### BRIEF DESCRIPTION OF THE DRAWINGS

FIG. 1 illustrates a short DNA polymer.

FIGS. 2A-B illustrate the hydrogen bonding between the purine and pyrimidine bases of two anti-parallel DNA strands.

FIG. 3 illustrates a short section of a DNA double helix comprising a first strand and a second, anti-parallel strand.

FIG. 4 illustrates a grid-like, two-dimensional pattern of square features.

FIG. 5 shows a number of target molecules hybridized to complementary probes, which are in turn bound to the surface of the microarray.

FIG. 6 illustrates the bound labeled DNA molecules detected via optical or radiometric scanning.

FIG. 7 illustrates optical, radiometric, or other types of scanning produced by an analog or digital representation of the microarray.

FIG. 8 shows a small region of a scanned image of a microarray containing the image of a single feature.

FIG. 9 shows a two-dimensional array of pixel-intensity values corresponding to a portion of the central, disc-shaped region corresponding to a feature in the region of an image of a microarray shown in FIG. 8.

FIG. 10 shows an idealized representation of a feature, such as the feature shown in FIGS. 8, on a small section of the surface of a microarray.

FIG. 11 shows a graph of pixel-intensity values versus position along a line bisecting a feature in the scanned image of the feature.

FIGS. 12-14 illustrate three of many possible misalignments between the rows and columns of features in a microarray image and internal coordinate axes of a microarray reader.

FIGS. 15A-B illustrate an example 3×3 kernel centered about pixel coordinates (x, y) in a microarray image.

FIGS. 16A-C illustrate an example application of a median-filter operator to filter noise.

FIG. 17A-B illustrate one of many possible methods for determining the N-percentile for a microarray of densely packed features.

FIGS. 18A-D illustrate four of many different median-filter-sample patterns that can be used to determine the background signal contribution to a microarray image.

FIGS. 19-20 illustrate constructing an example binary-microarray image.

FIGS. 21-22 illustrate smoothing the contour of feature.

FIG. 23 illustrates one of many possible schemes for labeling each feature with a unique integer value.

FIGS. 24A-E illustrate determining measurements for each feature of a binary-microarray image of a microarray.

FIG. 25 illustrates a binary-microarray image of a hypothetical microarray after feature filtering has been completed.

FIG. 26 illustrates hypothetical centroids of the features shown in FIG. 24.

FIGS. 27-28 illustrate fitting a least-squares line to a collection of top-edge-feature centroids.

FIG. 29 illustrates the least-squares lines fit to the edge-feature centroids shown in FIG. 26.

FIG. 30 illustrates an regularly spaced, feature-coordinate grid superimposed on the features shown in FIG. 25.

FIG. 31 illustrates a portion of a microarray and an initial superimposed rectilinear feature-coordinate grid having features that do not coincide exactly with the horizontal and vertical grid line intersections.

FIG. 32 illustrates an initial step in the determination of the vertical grid lines described above with reference to FIG. 30.

FIG. 33 illustrates four of many different kinds of symmetric response functions centered about feature centroids.

FIG. 34 illustrates a perspective view of employing normalized distribution functions centered at feature centroids of a microarray to determine the vertical grid lines.

FIG. 35 illustrates determination of the optimum angle α based on three vertical projections of normal distribution functions.

FIG. 36 is a control-flow diagram for the routine “Grid Finding” that represents one of many possible embodiments of the present invention.

FIG. 37 illustrates the routine “Determined Feature-Coordinate Grid” that represents one of many possible embodiments of the present invention.

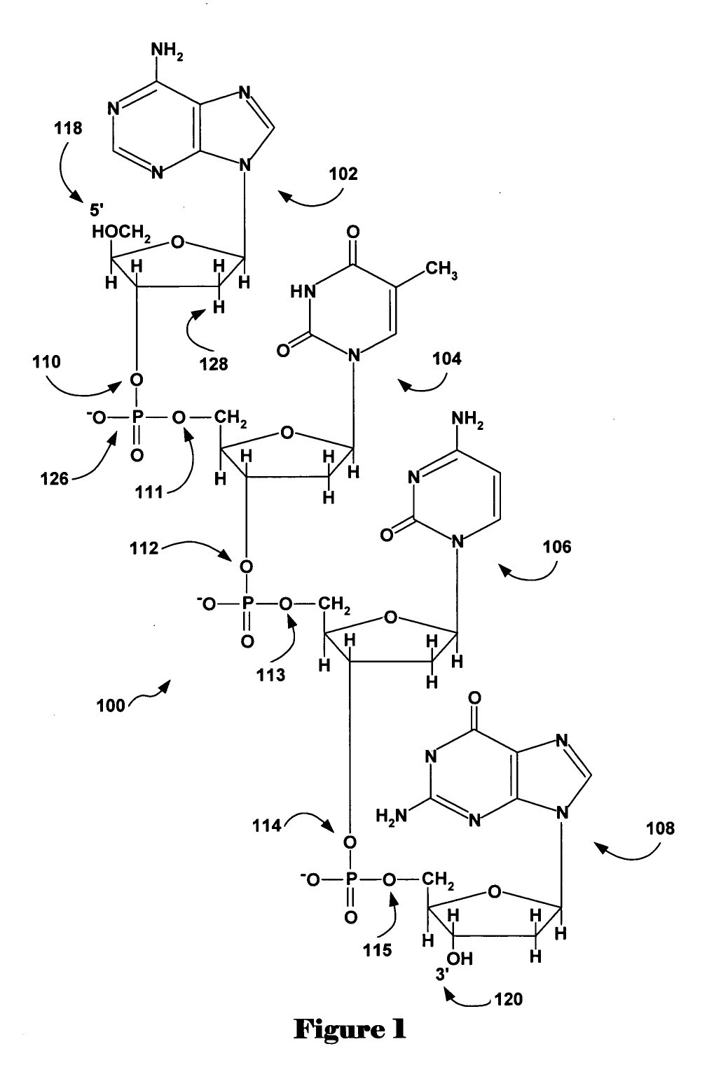

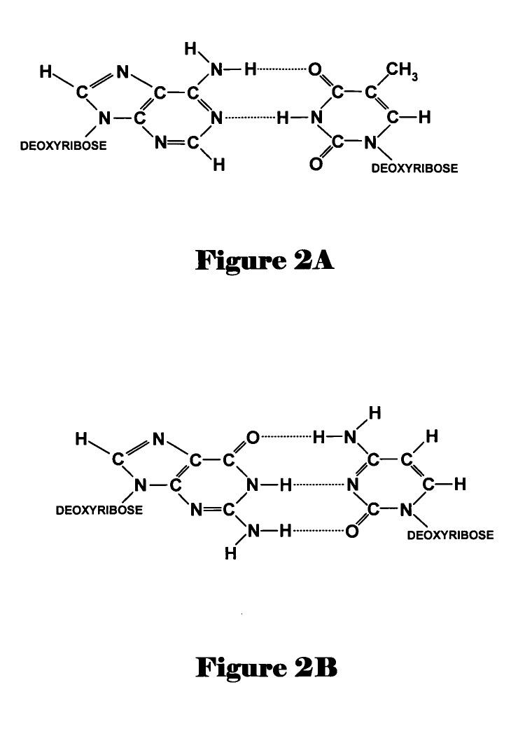

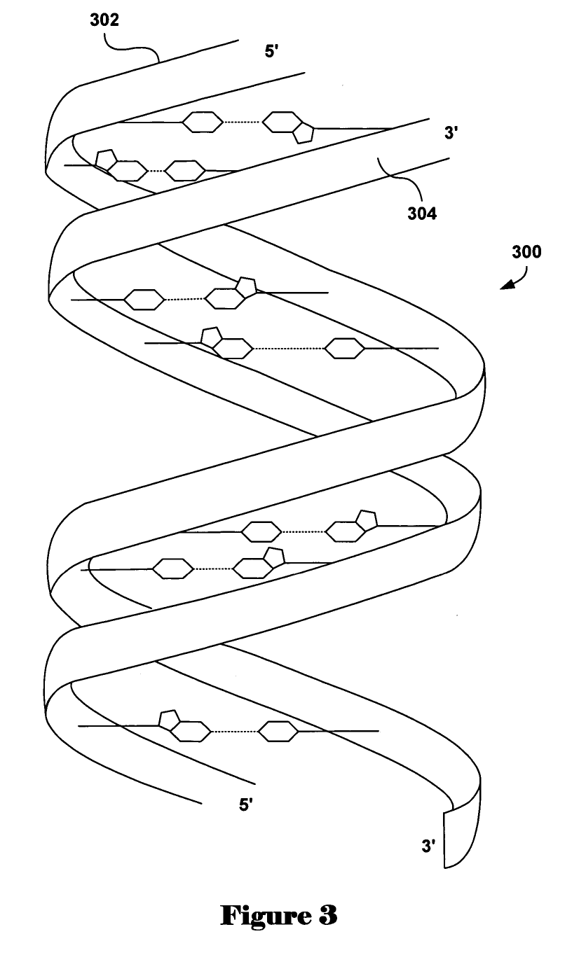

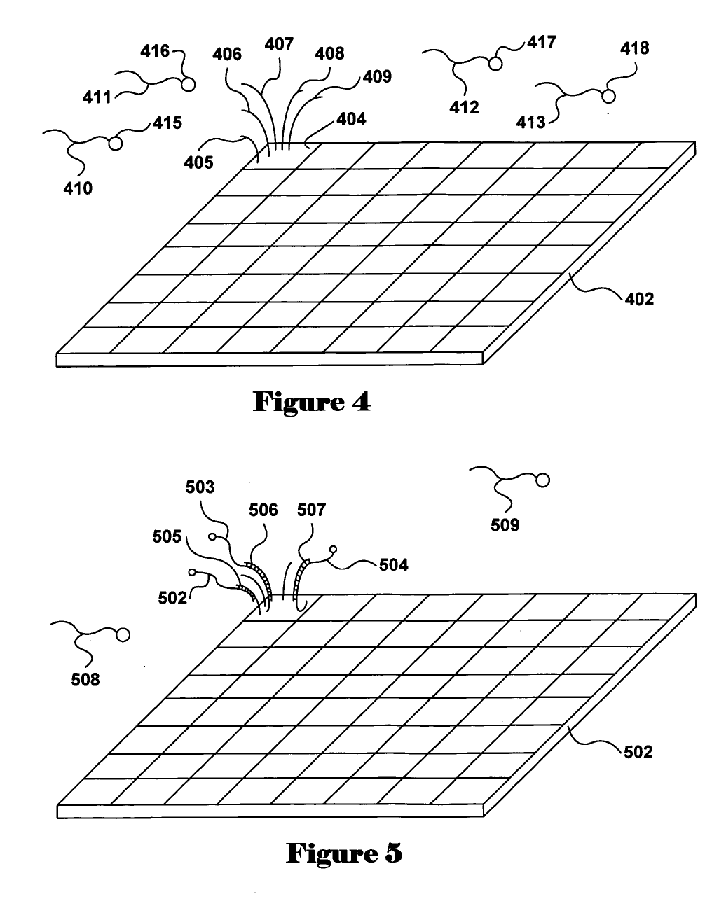

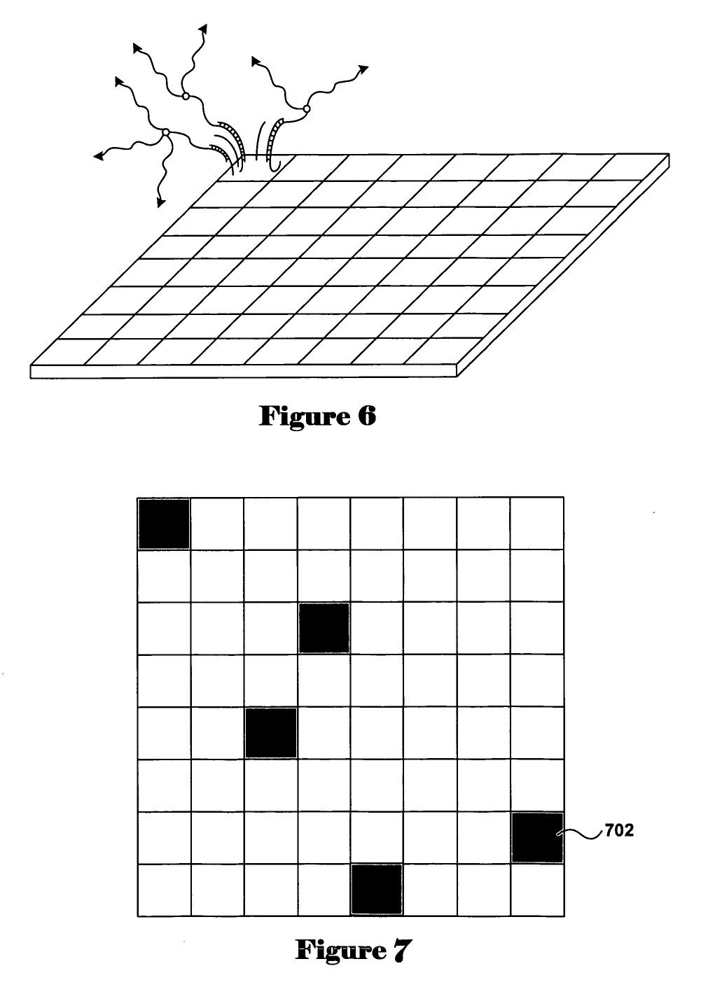

### DETAILED DESCRIPTION OF THE INVENTION

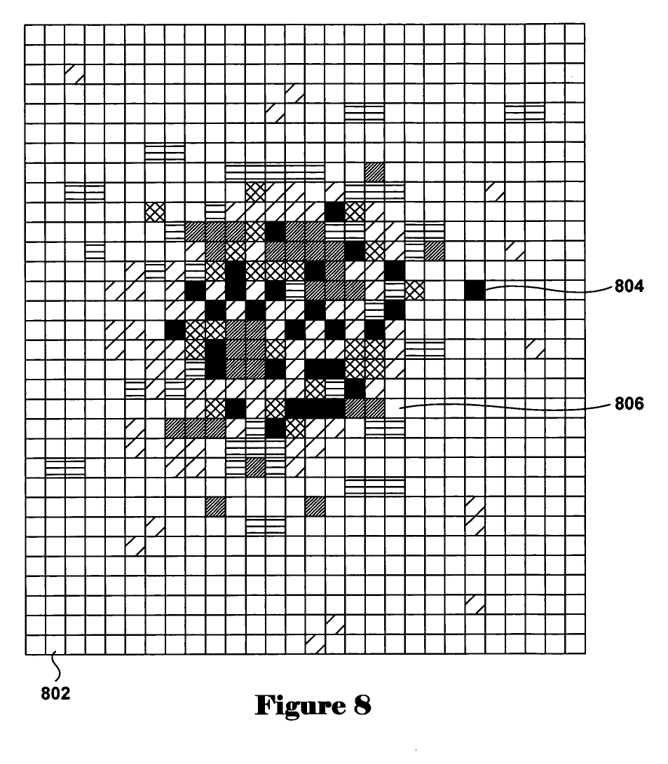

Typically, a microarray image or data set may exhibit a number of different kinds of artifacts, such as noise and background signal, and the arrangement of microarray features may be misaligned with microarray-reader axes. The above described artifacts and misalignment can make locating and isolating particular features for statistical analysis difficult. Various embodiments of the present invention are directed to methods for determining a feature-coordinate grid of the microarray image or data set that makes it possible to identify the coordinate-based location of individual features. The following discussion includes two subsections, a first subsection, including additional information about microarrays, and a second subsection describing embodiments of the present invention with reference to FIGS. 8-37.

### Additional Information About Microarrays

A microarray may include any one-, two-, or three-dimensional arrangement of addressable regions or features, each bearing a particular chemical moiety or moieties, such as biopolymers, associated with that region. Any given microarray substrate may carry one, two, or four or more microarrays disposed on a front surface of the substrate. Depending upon the use, any or all of the microarrays may be the same or different from one another and each may contain multiple spots or features. A typical microarray may contain more than ten, more than 100, more than 1,000, more 10,000 features, or even more than 100,000 features in an area of less than 20 cm² or even less than 10 cm². For example, square features may have widths or round features may have diameters in the range from a 10 μm to 1.0 cm. In other embodiments, each feature may have a width or diameter in the range of 1.0 μm to 1.0 mm, usually 5.0 μm to 500 μm, and more usually 10 μm to 200 μm. Features other than round or square may have area ranges equivalent to that of circular features with the foregoing diameter ranges. At least some, or all, of the features may be of different compositions (for example, when any repeats of each feature composition are excluded the remaining features may account for at least 5%, 10%, or 20% of the total number of features). Interfeature areas are typically, but not necessarily, present. Interfeature areas generally do not carry probe molecules. Such inter-feature areas typically are present where the microarrays are formed by processes involving drop deposition of reagents but may not be present when, for example, photolithographic microarray fabrication processes are used. When present, interfeature areas can be of various sizes and configurations.

Each microarray may cover an area of less than 100 cm², or even less than 50 cm², 10 cm², or 1 cm². In many embodiments, the substrate carrying the one or more microarrays will be shaped generally as a rectangular solid having a length of more than 4 mm and less than 1 m, usually more than 4 mm and less than 600 mm, more usually less than 400 mm; a width of more than 4 mm and less than 1 m, usually less than 500 mm, and more usually less than 400 mm; and a thickness of more than 0.01 mm and less than 5.0 mm, usually more than 0.1 mm and less than 2 mm, and more usually more than 0.2 and less than 1 mm. Other shapes are possible as well. With microarrays that are read by detecting fluorescence, the substrate may be of a material that emits low fluorescence upon illumination with the excitation light. Additionally, in this situation, the substrate may be relatively transparent to reduce the absorption of the incident illuminating laser light and subsequent heating if the focused laser beam travels too slowly over a region. For example, a substrate may transmit at least 20%, or 50%, (or even at least 70%, 90%, or 95%) of the illuminating light incident on the front as may be measured across the entire integrated spectrum of such illuminating light or alternatively at 532 nm or 633 nm.

Microarrays can be fabricated using drop deposition from pulsejets of either polynucleotide precursor units (such as monomers) in the case of in situ fabrication, or the previously obtained polynucleotide. Such methods are described in detail, for example, in U.S. Pat. Nos. 6,242,266; 6,232,072; 6,180,351; 6,171,797; 6,323,043; U.S. patent application Ser. No. 09/302,898 filed Apr. 30, 1999, by Caren et al., and the references cited therein. Other drop deposition methods can be used for fabrication, as previously described herein. Also, instead of drop deposition methods, photolithographic microarray fabrication methods may be used. Interfeature areas need not be present particularly when the microarrays are made by photolithographic methods as described in those patents.

A microarray is typically exposed to a sample including labeled target molecules or, as mentioned above, to a sample including unlabeled target molecules followed by exposure to labeled molecules that bind to unlabeled target molecules bound to the microarray, and the microarray is then read. Reading of the microarray may be accomplished by illuminating the microarray and reading the location and intensity of resulting fluorescence at multiple regions on each feature of the microarray. For example, a scanner may be used for this purpose which is similar to the AGILENT MICROARRAY SCANNER manufactured by Agilent Technologies, Palo Alto, Calif. Other suitable apparatus and methods are described in published U.S. Patent Application Nos. 20030160183A1; 20020160369A1; 20040023224A1; and 20040021055A, as well as U.S. Pat. No. 6,406,849. However, microarrays may be read by any other method or apparatus than the foregoing, with other reading methods including other optical techniques, such as detecting chemiluminescent or electroluminescent labels, or electrical techniques, for where each feature is provided with an electrode to detect hybridization at that feature in a manner disclosed in U.S. Pat. No. 6,251,685 and elsewhere.

A result obtained from reading a microarray, followed by application of a method of the present invention, may be used in that form or may be further processed to generate a result such as that obtained by forming conclusions based on the pattern read from the microarray, such as whether or not a particular target sequence may have been present in the sample or whether or not a pattern indicates a particular condition of an organism from which the sample came. A result of the reading, whether further processed or not, may be forwarded, such as by communication, to a remote location if desired and received there for further use, such as for further processing. When one item is indicated as being remote from another, this is referenced that the two items are at least in different buildings and may be at least one mile, ten miles, or at least 100 miles apart. Communicating information references transmitting the data representing that information as electrical signals over a suitable communication channel; for example, over a private or public network. Forwarding an item refers to any means of getting the item from one location to the next, whether by physically transporting that item or, in the case of data, physically transporting a medium carrying the data or communicating the data.

As pointed out above, microarray-based assays can involve other types of biopolymers, synthetic polymers, and other types of chemical entities. A biopolymer is a polymer of one or more types of repeating units. Biopolymers are typically found in biological systems and particularly include polysaccharides, peptides, and polynucleotides, as well as their analogs, such as those compounds composed of or containing amino acid analogs or non-amino-acid groups, or nucleotide analogs or non-nucleotide groups. This includes polynucleotides in which the conventional backbone has been replaced with a non-naturally occurring or synthetic backbone and nucleic acids, or synthetic or naturally occurring nucleic-acid analogs, in which one or more of the conventional bases has been replaced with a natural or synthetic group capable of participating in Watson-Crick-type hydrogen bonding interactions. Polynucleotides include single or multiple-stranded configurations where one or more of the strands may or may not be completely aligned with another. For example, a biopolymer includes DNA, RNA, oligonucleotides, and PNA and other polynucleotides as described in U.S. Pat. No. 5,948,902 and references cited therein, regardless of the source. An oligonucleotide is a nucleotide multimer of about ten to 100 nucleotides in length, while a polynucleotide includes a nucleotide multimer having any number of nucleotides.

As an example of a non-nucleic-acid-based microarray, protein antibodies may be attached to features of the microarray that would bind to soluble labeled antigens in a sample solution. Many other types of chemical assays may be facilitated by microarray technologies. For example, polysaccharides, glycoproteins, synthetic copolymers, including block copolymers, biopolymer-like polymers with synthetic or derivitized monomers or monomer linkages, and many other types of chemical or biochemical entities may serve as probe and target molecules for microarray-based analysis. A fundamental principle upon which microarrays are based is that of specific recognition by probe molecules affixed to the microarray of target molecules, whether by sequence-mediated binding affinities, binding affinities based on conformational or topological properties of probe and target molecules, or binding affinities based on spatial distribution of electrical charge on the surfaces of target and probe molecules.

Reading a microarray by an optical reading device or radiometric reading device generally produces a microarray image comprising a rectilinear grid of pixels, with each pixel having a corresponding signal intensity. These signal intensities are processed by a microarray-data-processing program that analyzes data scanned from a microarray to produce experimental or diagnostic results which are stored in a computer-readable medium, transferred to an intercommunicating entity via electronic signals, printed in a human-readable format, or otherwise made available for further use. Microarray experiments can indicate precise gene-expression responses of organisms to drugs, other chemical and biological substances, environmental factors, and other effects. Microarray experiments can also be used to diagnose disease, for gene sequencing, and for analytical chemistry. Processing of microarray data can produce detailed chemical and biological analyses, disease diagnoses, and other information that can be stored in a computer-readable medium, transferred to an intercommunicating entity via electronic signals, printed in a human-readable format, or otherwise made available for further use.

### Embodiments of the Present Invention

In general, a microarray reading device produces a microarray image or data set comprising an array of pixels, each pixel having a value representing an intensity measured from a corresponding element of the microarray. FIG. 8 shows a small region of a microarray image containing an image of a single feature. In FIG. 8, the small region of the microarray image comprises a grid, or matrix, of pixels, such as pixel 802. In FIG. 8, the magnitude of the signal read from the small region of the surface of a microarray spatially corresponding to a particular pixel in the image is indicated by a value, which may be used as a grayscale value for image display. For example, in FIG. 8, pixels corresponding to high-intensity signals, such as pixel 804, are darkly colored, while pixels having very low signal intensities, such as pixel 802, are not colored. The range of intermediate signal intensities is represented, in FIG. 8, by a generally decreasing density of crosshatch lines within a pixel. In FIG. 8 there is a generally disc-shaped region in the center of the region of the scanned image of the microarray that contains a high proportion of high-intensity pixels. Outside of this central, disc-shaped region corresponding to a feature, the intensities of the pixels fall off relatively quickly, although pixels with intermediate intensities are found, infrequently, even toward the edges of the region of the scanned image, relatively distant from the obvious central, disc-shaped region of high-intensity pixels that corresponds to the feature.

In general, data sets collected from microarrays comprise an indexed set of numerical signal intensities or pixel intensities, associated with small regions of the surface of a microarray. In many current systems, a 16-bit or 24-bit word is employed to store each pixel, and a data set can be considered to be a two-dimensional array of 16-bit or 24-bit values corresponding to the two-dimensional array of pixels that together compose a microarray image.

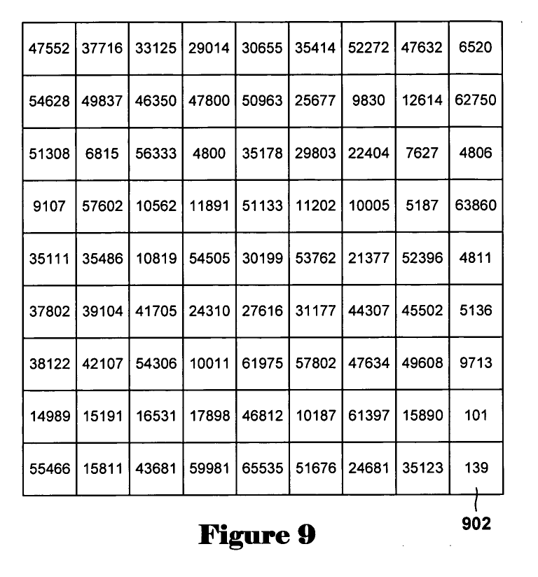

FIG. 9 shows a two-dimensional array of pixel-intensity values corresponding to a portion of the central, disc-shaped region of the feature shown in FIG. 8. In FIG. 9, for example, pixel intensity 902 corresponds to pixel 806 in FIG. 8.

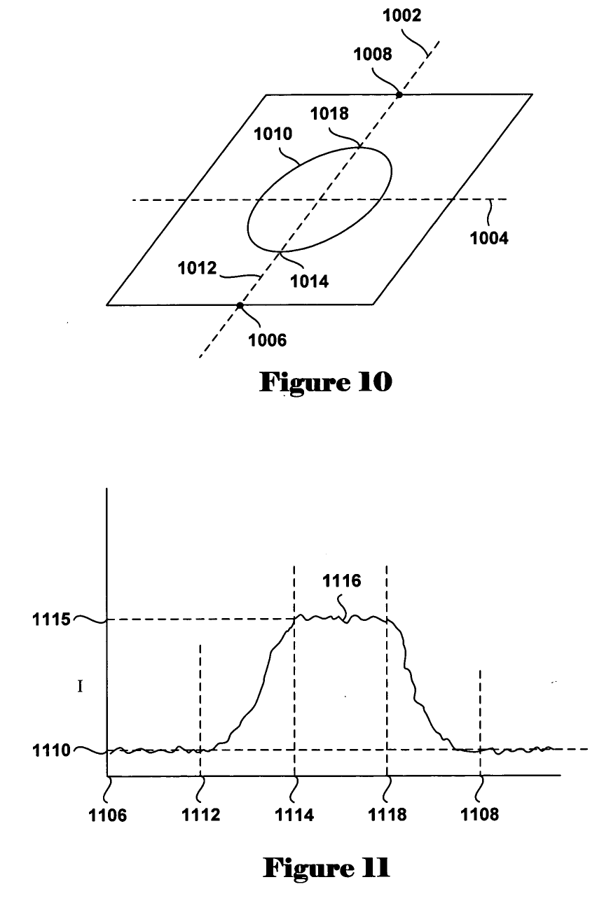

Features on the surface of a microarray may have various different shapes and sizes, depending on the manufacturing process by which the microarray is produced. In one class of microarrays, features are tiny, disc-shaped regions on the surface of the microarray produced by ink-jet-based application of probe molecules, or probe-molecular precursors, to the surface of the microarray substrate. FIG. 10 shows an idealized representation of a feature, such as the feature shown in FIG. 8, on a small section of the surface of a microarray. FIG. 11 shows a graph of pixel-intensity values versus position along a line bisecting a feature in the image of the feature. For example, the graph shown in FIG. 11 may be obtained by plotting the intensity values associated with pixels along lines 1002 or 1004 in FIG. 10. Consider a traversal of the pixels along line 1002 starting from point 1006 and ending at point 1008. In FIG. 11, points 1106 and 1108 along the horizontal axis correspond to positions 1006 and 1008 along line 1002 in FIG. 10. Initially, at positions well removed from the central, disc-shaped region of the feature in 1010, the scanned signal intensity is relatively low. As the central, disc-shaped region of the feature is approached, along line 1002, the pixels intensities remain at a fairly constant background level up to point 1012, corresponding to point 1112 in FIG. 11. Between points 1012 and 1014, corresponding to points 1112 and 1114 in FIG. 11, the average intensity of pixels rapidly increases to a relatively high intensity level 1115 at a point 1014 coincident with the outer edge of the central, disc-shaped region of the feature. The intensity remains relatively high over the central, disc-shaped region of the feature 1116 and begins to fall off starting at point 1018, corresponding to point 1118 in FIG. 11, at the far side of the central, disc-shaped region of the feature. The intensity rapidly falls off with increasing distance from the central, disc-shaped region of the feature until again reaching a relatively constant, background level at point 1008, corresponding to point 1108 in FIG. 11. The exact shape of the pixel-intensity-versus-position graph, and the size and shape of the feature, are dependent on the particular type of microarray and molecular-array substrate, chromophore or a radioisotope used to label target molecules, experimental conditions to which the microarray is subjected, the microarray reader used to read a microarray, and on data processing components of the microarray reader and an associated computer that produce the image and pixel-intensity data sets. For example, with some types of microarray manufacture processes or with different hybridization and washing protocols, the features may resemble donuts or even more irregular blobs. The microarray features are typically manufactured to lie in regularly spaced rows and columns.

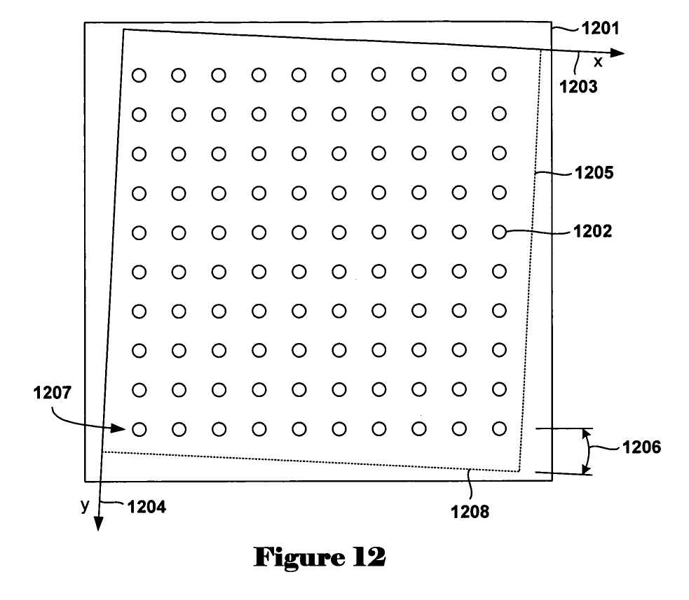

FIGS. 12-14 illustrate three of many possible misalignments between the rows and columns of features in a microarray image and internal coordinate axes of a microarray reader. Note that in FIGS. 12-14, and in subsequent Figures, the features used to illustrate the methods of the present invention are disc-shaped features, as described above with reference to FIGS. 10-11. However, the methods of the present invention are not limited to determining a feature-coordinate grid for microarrays having disk-shaped features and can be applied to determine a feature-coordinate grid for microarrays having triangular, square, pentagonal, and hexagonal features and features with regular shapes, and may also be applied to microarrays having irregularly shaped features.

FIG. 12 illustrates a hypothetical microarray having an arrangement of regularly spaced, disc-shaped features that is misaligned with the internal coordinate axes of the microarray reader. In FIG. 12, microarray 1201 includes an array of features having 10 rows and 10 columns of regularly spaced, disc-shaped features, such as disc-shaped feature 1202. Horizontal line 1203 and vertical line 1204 identify the internal x and y coordinate axes, respectively, of a microarray image read by the microarray reader. Dashed lines, such as dashed line 1205, identify two edges of the microarray image read by the microarray reader. Note that due to misalignment of microarray 1201 with respect to internal x and y coordinate axes of the microarray reader, the rows and columns of features are not parallel with the microarray-image edges. For example, angle 1206 identifies a non-zero angle between bottom-feature row 1207 and microarray-image edge 1208.

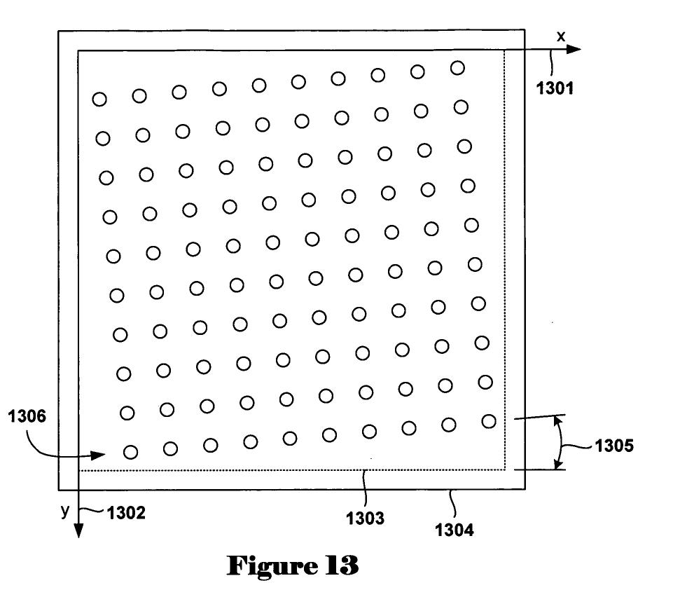

FIG. 13 illustrates a hypothetical microarray having an arrangement of regularly spaced, disc-shaped features that is misaligned with the microarray reader internal coordinates axes due to misalignment of the microarray substrate edges with the feature depositing jets employed in the microarray manufacturing process. Horizontal line 1301 and vertical line 1302 identify the internal x and y coordinate axes, respectively, of a microarray image read by the microarray reader. Dashed lines, such as dashed line 1303, identify the edges of the microarray image read by the microarray reader. Note that even though the microarray-image edges, such as microarray-image edge 1303, and the microarray edges, such as microarray edge 1304, are parallel, the regularly spaced features are not aligned with the microarray-image edges. For example, angle 1305 identifies the non-zero angle between bottom-feature row 1306 and microarray-image edge 1303.

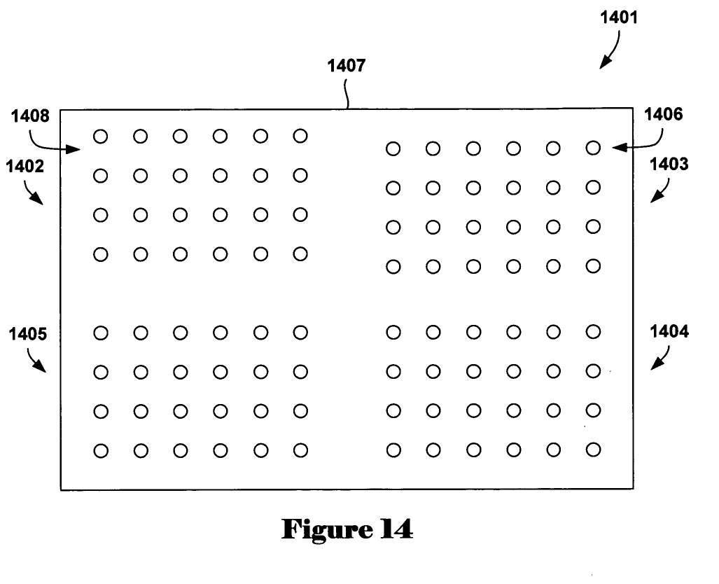

FIG. 14 illustrates a hypothetical microarray having four separate subgrids of regularly spaced microarray features. In FIG. 14, microarray 1401 is composed of subgrids 1402-1405. Note that the columns of features of subgrid 1402 are aligned with the columns of features of subgrid 1405, and that the rows of features of subgrid 1405 are aligned with the rows of features of subgrid 1404. However, the rows of features of subgrid 1403 are not aligned with the rows of features of subgrid 1402. For example, top-feature row 1406 of subgrid 1403 is located farther from microarray edge 1407 than top-feature row 1408 of subgrid 1402.

After the microarray image or data set is obtained, a value of the microarray-image-data-set noise, referred to as the “noise value,” is determined. The noise value can be determined using pixel-intensity values located in the interfeature areas. For example, if features account for 60 percent of the microarray image, then the interfeature area accounts for the remaining 40 percent of the microarray image. The noise value is determined by rank ordering the pixel-intensity values and computing the mean or median pixel-intensity value for those pixels with pixel-intensity values that comprise the lowest 40 percent of the rank ordered pixel-intensity values.

Next, the microarray image can be optionally preprocessed to correct for the microarray-signal noise and pixels having high pixel-intensity values relative to neighboring pixels. One of many possible methods for correcting for noise and pixels having high pixel-intensity value is to employ an image filter. An image filter can be represented by an image-filter operator given by:
I′(x,y)=T[I(x,y)]

where (x, y) are pixel coordinates,
I(x, y) is the pixel-intensity value associated with a pixel having pixel coordinates (x, y),
I′(x, y) is the processed pixel-intensity value, and
T is an image-filter operator defined over some neighborhood centered at pixel coordinates (x, y).
   The approach to defining a neighborhood about (x, y) is to use a square or rectangular sub-image area composed of pixels in the neighborhood of (x, y). The neighborhood centered about pixel coordinates (x, y) is referred to as a “mask” or “kernel.” Each pixel within a kernel centered about the pixel is separately considered to determine I′(x, y) for each pixel.

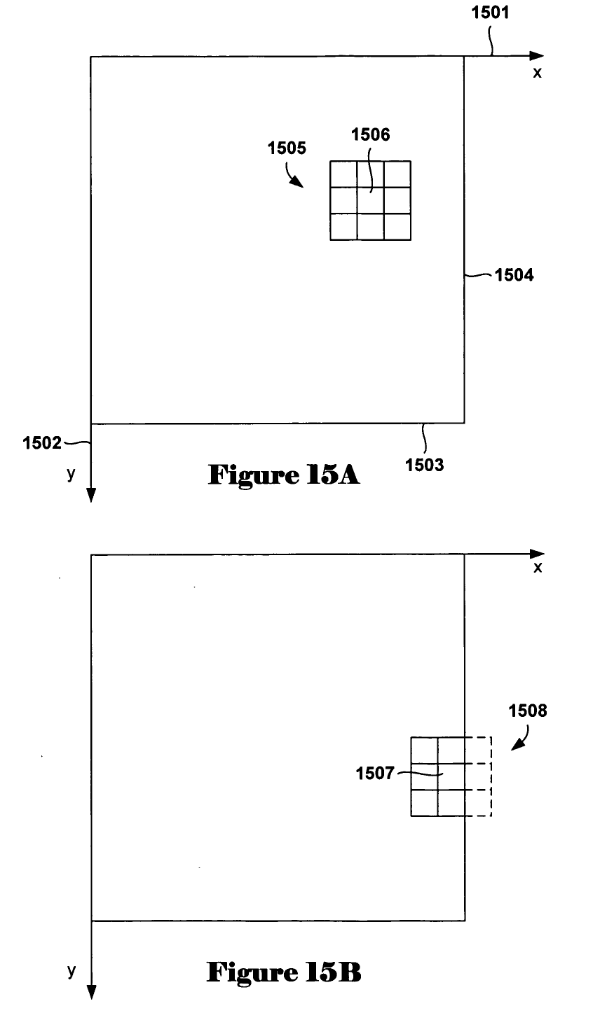

FIGS. 15A-B illustrate an example 3×3 kernel centered about pixel coordinates (x, y) in a microarray image. In FIGS. 15A-B, horizontal, such as horizontal axis 1501, are the x-coordinate axes in pixel units, and vertical axes, such as vertical axis 1502, are the y-coordinate axes in pixel coordinates of the microarray image. In FIG. 15A, the microarray image read by the microarray reader is bounded along the top edge by horizontal axis 1501, along the bottom edge by horizontal line 1503, along the left edge by vertical axis 1502, and along the right edge by vertical line 1504. The 3×3 grid of pixels 1505 identifies a 3×3 kernel centered about pixel 1506. The filter operator T uses all of the pixels located within kernel 1505 to obtain I′(x,y) at pixel 1506. FIG. 15B illustrates application of a filter operator T to pixels located along the edge of a microarray image. The filter operator T uses the six pixels contained within 3×3 kernel 1508 to determine I′(x, y) at pixel 1507.

One of many possible methods for filtering noise and pixels having high pixel-intensity values is to use an N-percentile-filter operator, where N represents a percentile value. The pixel-intensity values of a kernel are placed in rank order from smallest pixel-intensity value to largest pixel-intensity value. The N-percentile is a value on a scale ranging from zero to one-hundred that indicates the percent of the rank ordered pixel-intensity values in the kernel that are equal to or less than the N-percentile pixel-intensity value. For example, a pixel in a kernel having a pixel-intensity value of 9,534 that is greater than or equal to 70% of the pixel-intensity values in the kernel is the 70^{th}-percentile pixel-intensity value. In other words, the 70^{th}-percentile, pixel-intensity value 9,534 means that 70% of the pixels in the kernel have a pixel-intensity value less than 9,534. A particular example application of an N-percentile-filter operator is the median-filter operator. The median-filter operator replaces the center pixel-intensity value of the kernel with the median (N=50) of all the pixel-intensity values within a kernel. The median pixel-intensity value of a set of pixel-intensity values is the pixel-intensity value, such that when the set of pixel intensity values are rank ordered by intensity value, there is an equal number of pixel-intensity values above and below the median pixel-intensity value or when there is no single middle pixel-intensity value, the median pixel-intensity value is the arithmetic mean of the two middle pixel-intensity values. The kernel size employed with a median filter operator used to filter noise and pixels having high pixel-intensity values may range from 9 (3×3 kernel) to 81 (9×9 kernel) pixels or larger. Note that median-filter operators preserve the image sharpness of feature edges and is useful for removing noise from microarrays having a low density of microarray features..

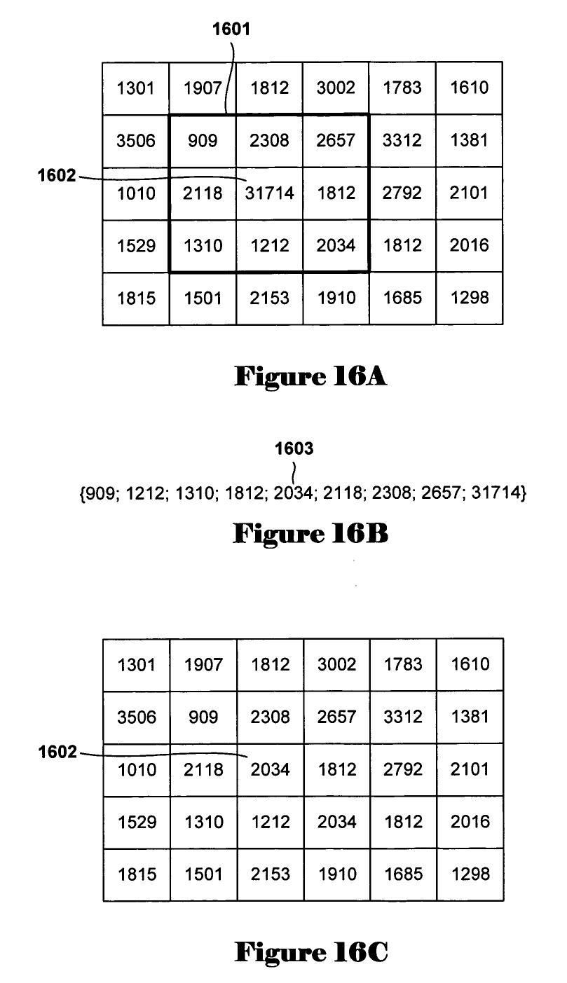

FIGS. 16A-C illustrate an example application of a median-filter operator to filter noise. FIG. 16A illustrates a two-dimensional array of pixel-intensity values corresponding to a portion of a microarray image. Bold horizontal lines and bold vertical lines, such as bold horizontal line 1601, identify the boundaries of an example 3×3 kernel centered about pixel 1602. Pixel 1602 represents a pixel having an high pixel-intensity value relative to neighboring pixels. The median-filter operator determines the median signal intensity based on the pixel-intensity values of all pixels within the 3×3 kernel. In order to perform median filtering the pixel-intensity within the 3×3 kernel are rank ordered. FIG. 16B shows a rank ordering of the intensity values within the 3×3 kernel, shown in FIG. 16A, from the lowest pixel-intensity value to the highest pixel-intensity value. The fifth intensity value 1603 identifies the median pixel-intensity value for the kernel shown in FIG. 16A. FIG. 16C shows the two-dimensional array of pixel intensity values, shown in FIG. 16A, after the median-filer operator has been applied to pixel 1602. In FIG. 16C, the intensity value 31,714 associated with pixel 1602, shown in FIG. 16A, is replaced by median intensity value (2,034) 1603, shown in FIG. 16B.

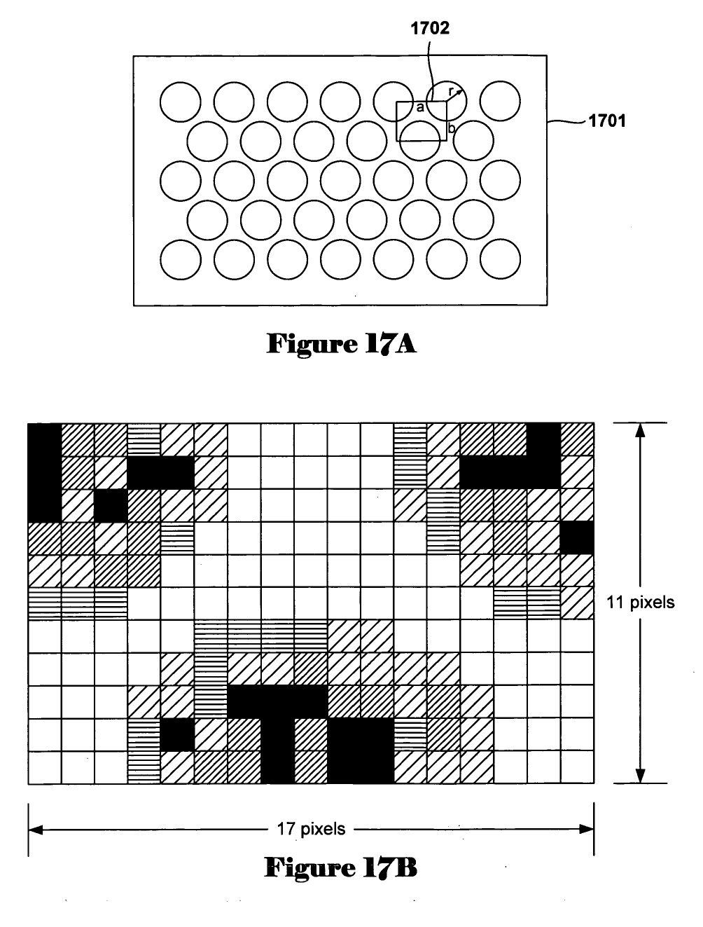

Features in alternative types of microarrays may be arranged to cover the surface of the microarray at higher densities, such as by offsetting the features in adjacent rows to produce a more closely packed arrangement of features. FIG. 17A illustrates one of many possible ways features of a microarray can be arranged to give a microarray having a higher density of features than a microarray having regularly spaced microarray features. As a result, the median filter operator may be inadequate for removing noise form densely packed microarrays. The N-percentile that can be used for filtering densely packed microarrays, such as the densely packed microarray illustrated in FIG. 17A, is given by:

$$N\_Percentile = \frac{1}{2} ( 1 - \frac{π {r}^{2}}{a \cdot b} ) \cdot 100$$

where r is the feature radius;
a is the horizontal spacing of feature centers in a row; and
b is the vertical spacing of feature centers in a column.
   The N_Percentile is based on the size of a rectangular unit cell that contains a single feature. The horizontal spacing of feature centers in a row, a, and the vertical spacing of feature centers in a column, b, form the sides of the unit cell. In FIG. 17A, a hypotheitcal unit cell, in densely packed microarray 1701, is identified by the rectangle 1702. After the pixel-intensity values of the kernel are rank ordered, the N-percentile calculated according to N_Percentile is used to determine the pixel-intensity value located at the center pixel of the kernel. For example, FIG. 17B illustrates a close-up view of the hypothetical unit cell, shown in FIG. 17B. The features are identified by pixels of varying intensities, as described above with reference to FIG. 8. For the unit cell, shown in FIG. 17B, the horizontal spacing of feature centers in a row, a, is “17” pixels, and the vertical spacing of feature centers in a column, b, is “11” pixels. The N-percentile, calculated according to N_Percentile, can be used to determine the pixel-intensity value located at the center of 3×3 kernel 1601, shown in FIG. 16A. Substituting the values “17” and “11” for the parameters a and b and assigning the radius r the value “6” gives an N Percentile value of approximately “20.” The 20^{th}-percentile of the rank order pixel-intensity values, shown in FIG. 16B, is 1,212, which replaces the pixel-intensity value located at the center of 3×3 kernel 1601.

The background signal generated during reading regions of the surface of a microarray outside of the areas corresponding to features arises from many different sources, including contamination of the microarray surface by fluorescent or radioactively labeled or naturally radioactive compounds, fluorescent, or radiation emission from the microarray substrate, dark signal generated by the photo detectors in the microarray reader, and many other sources. When this background signal is measured on the portion of the microarray that is outside of the areas corresponding to a feature, it is often referred to as the local background signal.

An important part of microarray data processing is subtraction of the background signal from the microarray-image-pixel-intensity values. With appropriate background signal subtraction, it is possible to distinguish low-signal features from no-signal features, and to calculate accurate and reproducible log ratios between multi-channel and/or inter-microarray data. Subtracting the background signal from the processed microarray image can be represented by:
I_{BS}(x,y)=I′(x,y)−B(x,y)

where B(x, y) is the background-signal-intensity value, and

I_{BS}(x,y) is the background-subtracted pixel-intensity value.

A background signal intensity value B (x, y) can be determined from the microarray image by applying a median-filter operator on the microarray image I(x,y) or applying the median filter on the optionally processed microarray image I′(x,y). The kernel size used to determine the background signal is based on the typical size of a microarray feature. For example, a 21×21 kernel can be used to determine the background signal of a microarray having disc-shaped features with a diameter of about 10 pixels.

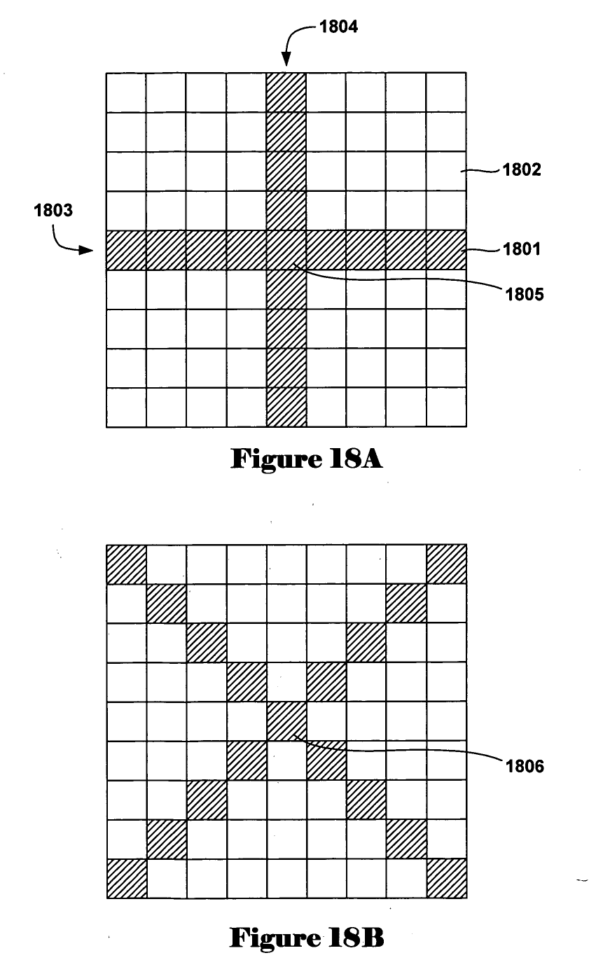

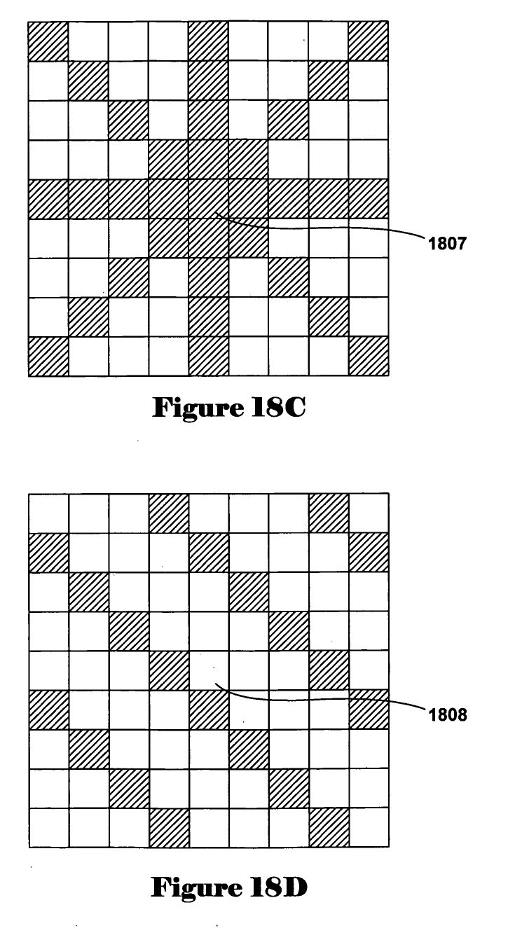

Typically, a median-filter operator utilizes all pixels located within the kernel. However, rank ordering the pixel-intensity values for large kernels, such as a 21×21 kernel, is the most computationally demanding part of the median filtering process. The median filtering process for large kernels can be speeded up by using a median-filter operator that samples the pixels within a kernel rather than using all pixels within the kernel. FIGS. 18A-D illustrate four of many different median-filter-sample patterns that can be used to determine the background signal contribution to a microarray image. In FIGS. 18A-D, four example 9×9 kernels are shown. Hash-marked pixels, such as hash-marked pixel 1801, shown in FIG. 18A, identify the pixels used to determine the median intensity for the pixel located at the center of the kernel, and unmarked pixels, such as pixel 1802, shown in FIG. 18A, identify pixels within each kernel that are not included in determining the median pixel intensity. FIG. 18A illustrates a median-filter-sample pattern that uses a crossing vertical line of hash-marked pixels and a horizontal line of hash-marked pixels. In FIG. 18A, horizontal line of hash-marked pixels 1803 crosses vertical line of hash-marked pixels 1804 at center hash-marked pixel 1805. The hash-marked pixels composing vertical line 1803 and horizontal line 1804 are used to determine the median intensity at center hash-marked pixel 1805. In FIG. 18B, two crossing diagonal lines of hash-marked pixels are used to determine the median intensity at center hash-marked pixel 1806. The median-filter-sample pattern, shown in FIG. 18C, is constructed by combining the median-filter-sample patterns shown FIGS. 18A-B. The hash-marked pixels shown in FIG. 18C are used to determine the median filter intensity at center hash-marked pixel 1807. In FIG. 18D, every fourth pixel is employed in row-by-row sequential order to determine the median intensity at center pixel 1808. Note that the present invention is not limited to the four median-filter-sample patterns shown in FIGS. 18A-D. Any pattern of features within a kernel can be utilized to determine the median intensity at the center pixel. Note also that pseudorandom sampling of pixels within a kernel can be used to determine the median-filter-sample pattern. Note that, in an alternate embodiment, the N_Percentile described above with reference to FIGS. 17A-B, can be used rather than the median filter operator.

Next, the method determines a binary-microarray image of the background-subtracted image. The binary-microarray image may be determined by assigning to pixels having intensity values greater than a threshold value a first value and assigning a second value to those pixels having pixel-intensity values less than the threshold value. One of many possible methods for determining the threshold value for the full microarray image is given by:
TV=NV−TNF·σ

where NV is the microarray image noise value, described above,
TNF is a threshold noise factor that is determined outside the scope of the present invention, and
σ is the standard deviation of the pixel-intensity values used to determine NV.

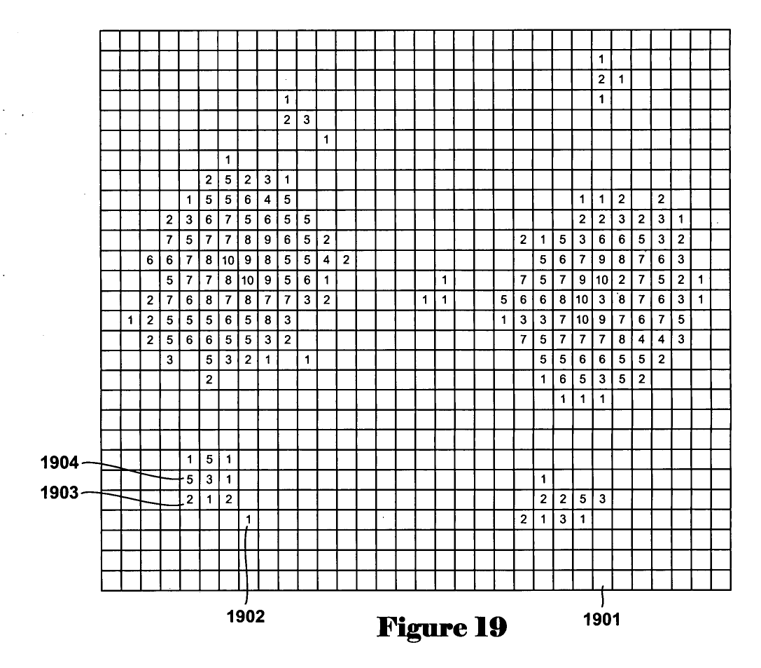

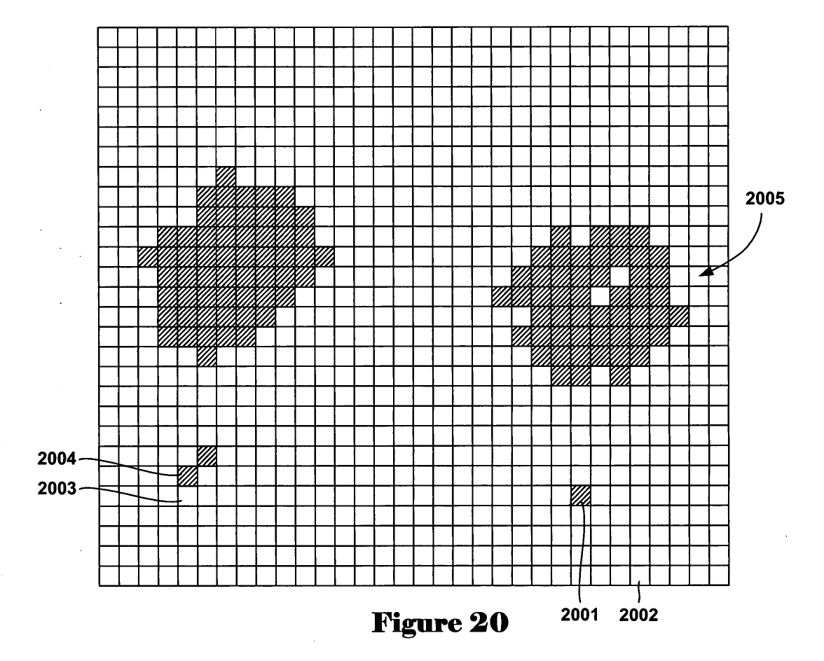

FIGS. 19-20 illustrate constructing an example binary-microarray image. FIG. 19 illustrates a portion of a background-subtracted image having two features. In FIG. 19, pixel intensities are represented by integers ranging from “0” to “10.” Pixels, such as pixel 1901, identify pixels having a “0” pixel-intensity value, and pixels that contain integer values, such as pixel 1902, identify those pixels having pixel-intensity values larger than “0.”

FIG. 20 illustrates the binary-microarray image of the two features shown in FIG. 19. In FIG. 20, hash-marked pixels, such as hash-marked pixel 2001, identify pixels, shown in FIG. 19, that have pixel-intensity values larger than a hypothetical threshold value of “3,” and unmarked pixels, such as pixel 2002, identify pixels, shown in FIG. 19, that have pixel-intensity values less than or equal to the hypothetical threshold value of “3.” For example, pixel 2003 represents pixel 1903, shown in FIG. 19, that has pixel-intensity value “2,” and hash-marked pixel 2004 represents the binary-microarray image of pixel 1904, shown in FIG. 19, that has a pixel-intensity value greater than threshold value “3.”

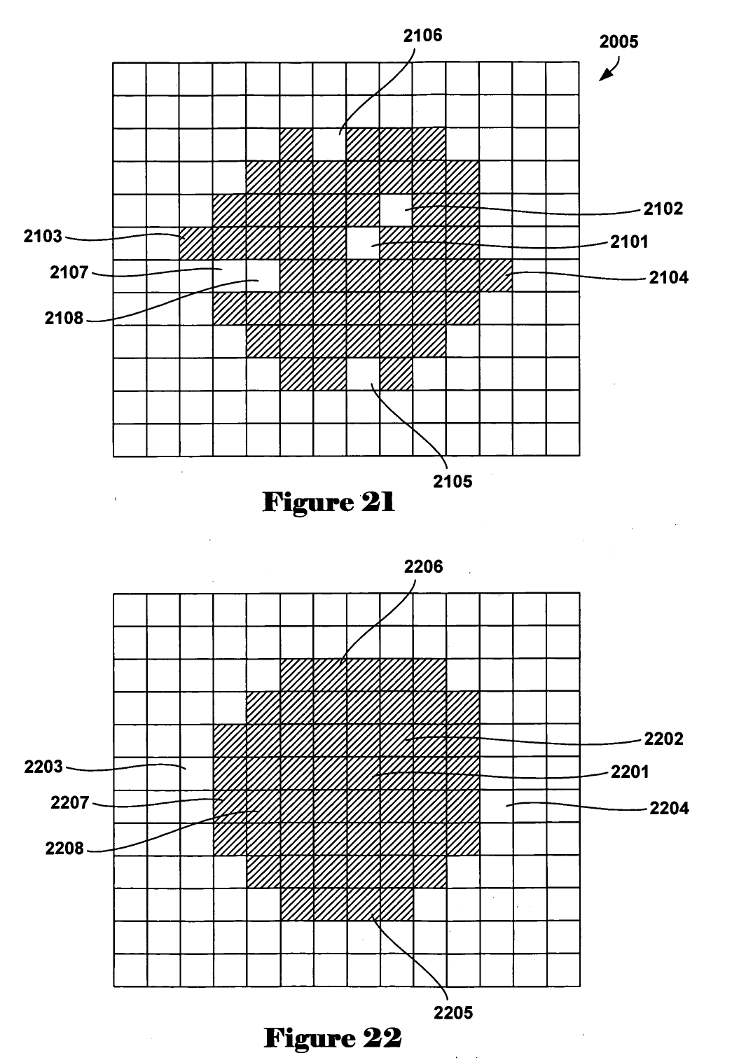

After the binary-microarray image of the background-subtracted image is determined, the method of the present invention smooths the contour of each feature by either adding or subtracting pixels as needed. Smoothing operations include, but are not limited to, a “fill operation,” an “erode operation,” a “dilation operation,” and a “closing operation.” FIGS. 21-22 illustrate application of the “fill,” “erode,” “dilate,” and “closing” operations to smooth the irregularly shaped contour of feature 2005, shown in FIG. 20, to give a disc-shaped feature. FIG. 21 illustrates an enlargement of feature 2005, shown in FIG. 20, and FIG. 22 illustrates the smoothed contour of disc-shaped feature 2005 after application of the “fill,” “erode,” “dilation,” and “closing” operations. The “fill operation” eliminates holes located entirely within a feature by filling in unmarked pixels located within the feature with hash-marked pixels. For example, in FIG. 21, unmarked pixels 2101 and 2102 identify holes located entirely within feature 2005. The “fill operation” replaces pixels 2101 and 2102 with hash-marked pixels 2201 and 2202, respectively, shown in FIG. 21. The “erode operation” smooths the contour of a feature by eliminating single protruding pixels. For example, the “erode operation” replaces protruding hash-marked pixels 2103 and 2104, shown in FIG. 21, with unmarked pixels 2203 and 2204, respectively, shown in FIG. 22. The “dilation operation” fills in gaps of single unmarked pixel that are located on the contour of a feature. For example, the “dilation operation” replaces unmarked pixels 2105 and 2106, shown in FIG. 21, with hash-marked pixels 2205 and 2206, respectively, shown in FIG. 22. The “closing operation” smooths the feature contour by filling in narrow breaks. For example, the narrow break identified by unmarked pixels 2107 and 2108, shown in FIG. 21, is closed by replacing unmarked pixels 2107 and 2108 with hash-marked pixels 2207 and 2208, respectively, shown in FIG. 22. Note that the “fill,” “erode,” “dilation,” and “closing” operations can be applied to any irregularly shaped feature and regularly shaped features, such as triangular, square, pentagonal, and hexagonal feature to smooth the contour of the feature.

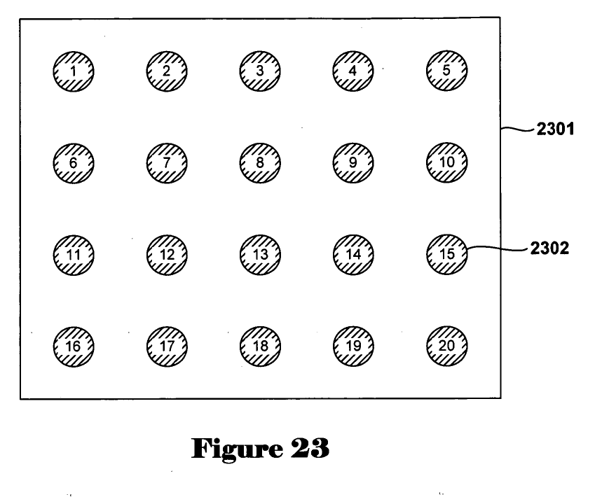

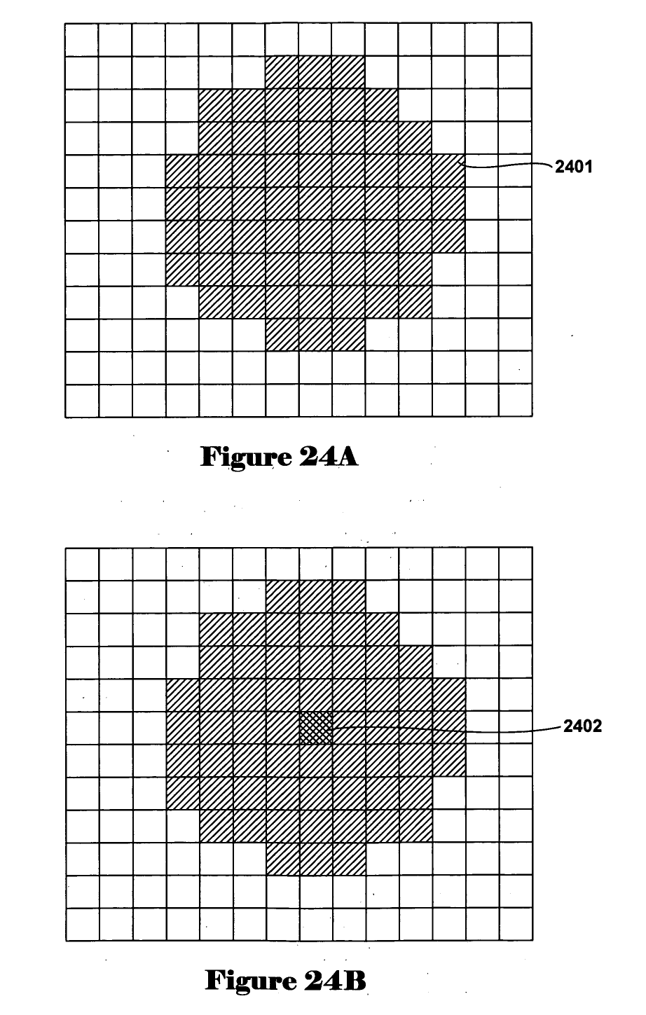

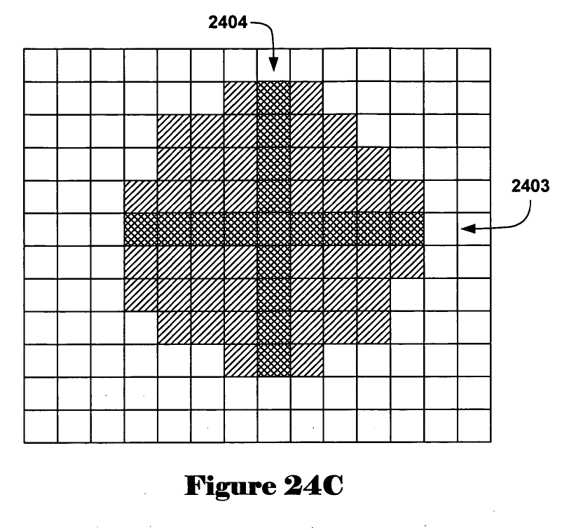

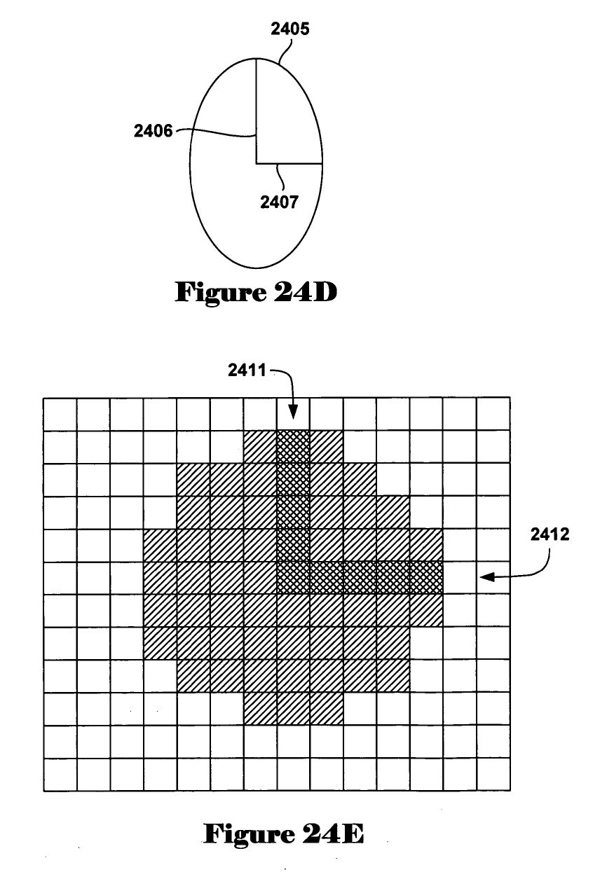

After each feature of the binary-microarray image has been smoothed, each feature is labeled with a unique integer value by assigning all contiguous pixels that compose a feature with a unique integer value. Contiguous pixels are those pixels that share a common pixel edge. The contiguous pixels of each feature are labeled so that, during feature extraction, features can be selected by their unique integer value for statistical analysis. FIG. 23 illustrates one of many possible schemes for labeling each feature with a unique integer value by assigning all contiguous pixels that compose a feature with a unique integer value. In FIG. 23, binary-microarray image 2301 is composed of 20 features. The pixels of each of the 20 features are labeled with an integer value unique to that feature. For example, the contiguous pixels of feature 2302 are all labeled with the integer value “15.” Next, FIGS. 24A-E illustrate determining measurements, such as the feature area, the centroid, spatial extent, aspect ratio, and fill factor, for each feature of a binary-microarray image of a microarray. The measurements can be used to establish criteria for filtering features from the binary-microarray image of the microarray image. In FIGS. 24A-E, an example binary-microarray image of a hypothetical feature is identified by hash-marked pixels, such as hash-marked pixel 2401, shown in FIG. 24A.

The area of a feature is determined by counting the number of pixels that compose the feature. For example, the area of the example feature shown in FIG. 24A is 61 pixels, as determined by counting the number of hash-marked pixels.

The coordinates of the centroid of a feature is determined by the following equations:

$$\overline{x} = {\sum }_{i = 1}^{n} \frac{{x}_{i}}{n} , and \overline{y} = {\sum }_{i = 1}^{n} \frac{{y}_{i}}{n}$$

where i is a feature coordinate index,
(xᵢ, yᵢ) are the feature-pixel coordinates, and
n is the number of pixels that compose the feature
   FIG. 24B illustrates the centroid of the example feature identified by cross-hatched pixel 2402.

The x-spatial extent is the maximum width of a feature in the x-coordinate direction, and the y-spatial extent is the maximum width of a feature in the y-coordinate direction. FIG. 24C illustrates the x-spatial extent and y-spatial extent for the example feature. The horizontal row of cross-hatched pixels 2403 identifies the x-spatial extent of the example feature, and the vertical column of cross-hatched pixels 2404 identifies the y-spatial extent of the example feature. The x-spatial extent and y-spatial extent of the example feature, shown in FIG. 24C, are both 9 pixels.

The eccentricity is a measure of the deviation of an ellipse or a spheroid from the form of a circle. The eccentricity can be determined by the following equations:

$$Eccentricity = \sqrt{1 - \frac{{d}^{2}}{{c}^{2}} }$$

$$where$$

$$c = {\sum }_{i}^{n} \vert {c}_{i} - \overline{c} \vert I ( {x}_{i} , {y}_{i} )$$

(first-degree moment along the semi-major axis);

$$d = {\sum }_{i}^{n} \vert {d}_{i} - \overline{d} \vert I ( {x}_{i} , {y}_{i} )$$

(first-degree moment along the semi-minor axis);

\overline{c} is the semi-major-axis-mean distance; and

\overline{d} is the semi-minor-axis-mean distance.

Note that c and d are respectively the first-degree moments about the mean values \overline{c} and \overline{d}. Note also that, for a binary image, feature-pixel-intensity values, I(xᵢ,yᵢ), are assigned the value “1.” FIG. 24D illustrates semi-major axis 2406 and semi-minor axis 2407 for ellipse 2405.

FIG. 24E illustrates the eccentricity of the example feature. The eccentricity for the example feature, shown in FIG. 24E, is zero, because both the semi-major axis 2411 and semi-minor axis 2412 are identically “5” pixels in length, which indicates that the example feature is nearly circular,.

The measurements determined above with reference to FIGS. 24A-E can be used to establish criteria for filtering labeled features of the binary-microarray image of a microarray. The criteria may impose limits on the feature surface area given by:
Accepted_Feature={Feature: C<Area_{Feature}<D}

where Area_{feature} is the area of a feature determined as described above with reference to FIG. 23A; and

C and D are parameters related to feature spacing or feature area.
Features having an area less than the value C or an area greater than the value D are filtered from the binary-microarray image of microarray. Eccentricity can be used as a criterion for filtering features. For example, features having an eccentricity value greater than 2 may be removed from the microarray data set. A parameter referred to as the fill factor can be used to filter features from the binary-microarray image of the microarray. The fill factor is given by:

$$Fill\_Factor = \frac{{Area}_{feature}}{x - extent \times y - extent}$$

where x—extent is the x-spatial extent, and

y—extent is the y-spatial extent.
For example, features having a Fill_Factor value greater than 0.5 can be filtered. Moreover, the aspect ratio, given by:

$$Aspect\_ratio = \frac{x - extent}{y - extent}$$

can also be used to filter features from the microarray data by, for example, removing features having an Aspect_ratio greater than “1.”

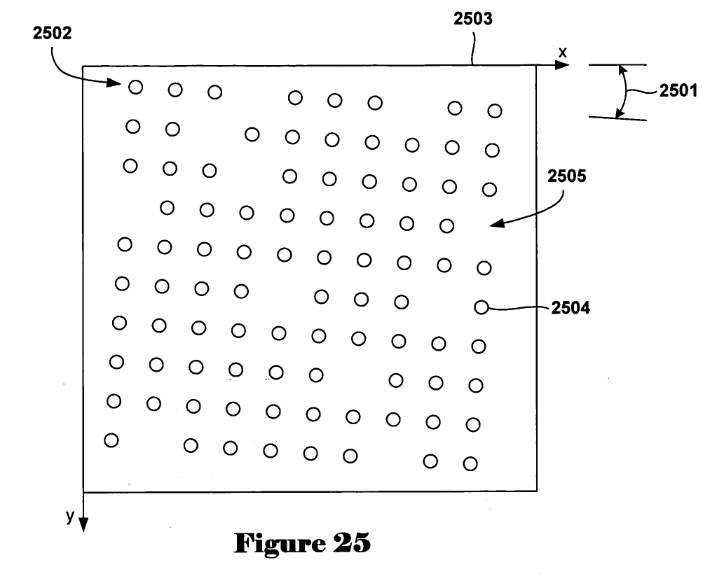

FIG. 25 illustrates a binary-microarray image of a hypothetical microarray after feature filtering has been completed, as described above with reference to FIGS. 24A-E. In FIG. 25, the regularly spaced features are misaligned with the pixel coordinate axes. For example, non-zero angle 2501 identifies the angle between top-feature row 2502 and x-pixel coordinate axis 2503 and indicates that top-feature row 2502 is not equidistant from axis 2503. Features that satisfy the filtering criteria are identified by disc-shaped features, such as disc-shaped feature 2504. Gaps between features, such as gap 2505, identify the location where filtered features previously existed.

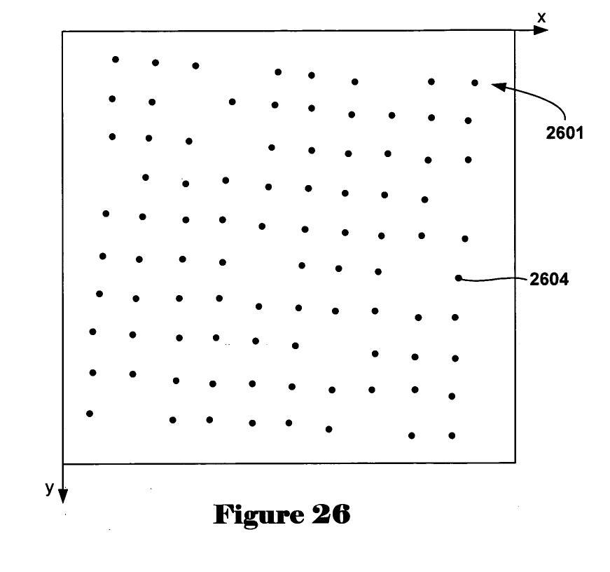

After the binary-microarray image of the microarray has been filtered, the centroids of edge features are employed to determine a feature-coordinate grid. FIG. 26 illustrates hypothetical centroids of the features shown in FIG. 25. In FIG. 26, the centroids of each feature, shown in FIG. 25, is represented by a point. For example, point 2604 identifies the centroid of feature 2504, shown in FIG. 25. The centroids located along the edges, such as centroids located along top edge 2601, are used to fit lines. One of many possible methods for fitting a line to the centroids located along the edge of a microarray is the least-squares method. For the least-squares method, a function E is defined as follows:

$$E ( a , b ) = {\sum }_{i = 1}^{m} {[ {y}_{i} - ( a \cdot {x}_{i} + b ) ]}^{2}$$

where (xᵢ, yᵢ) is a feature-centroid coordinate,
a is the slope of the least-squares line,
b is the y-intercept of the least-squares line, and
m is the number of feature centroids located along an edge.
   The least-squares method finds a best line fit to the feature-centroid coordinates by minimizing E with respect to the slope a and the y-intercept b, min_{a,b}E (a, b), to obtain a least-squares line given by:
   y=a·x+b

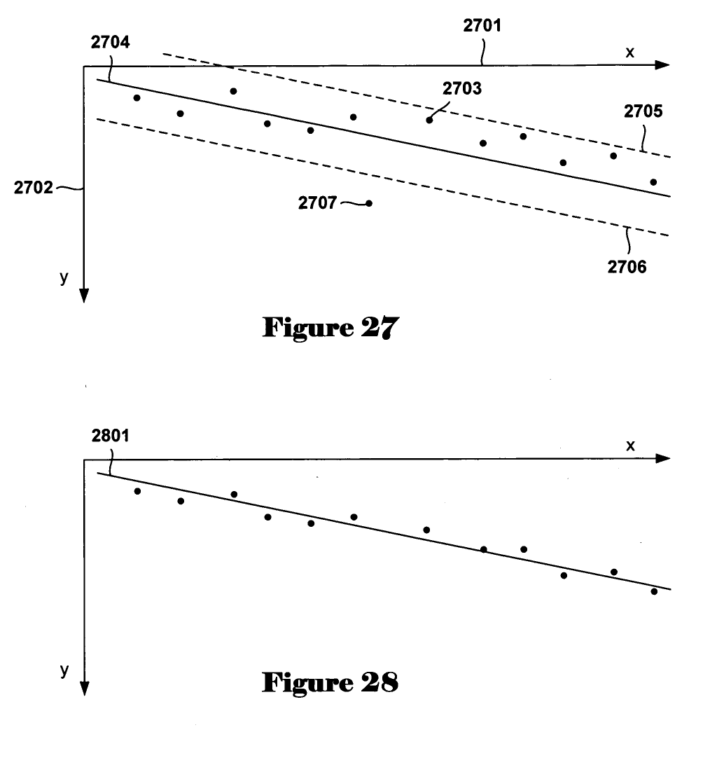

FIGS. 27-28 illustrate fitting a least-squares line to a collection of top-edge-feature centroids. In FIGS. 27-28, the units of the x-axis, such as x-axis 2701, and the units of the y-axis, such as vertical axis 2702, are pixels. Note that, for the sake of simplicity, only those feature centroids located along the top edge of a hypothetical microarray are displayed. Points, such as point 2703, identify the top-edge-feature centroids of the hypothetical microarray. Line 2704 identifies the least-squares line fit to the top-edge-feature centroids. Dashed line 2705, located above and parallel to least-squares line 2704, and dashed line 2706, located below and parallel to least-squares line 2704, identify tolerance bounds of least-squares line 2704. The top-edge-feature centroids are located outside the tolerance bounds are removed from the top-edge-feature-centroid-data set, and the least-squares line fitting is repeated. For example, top-edge-feature centroid 2707 is located outside tolerance bound 2706. Top-edge-feature centroid 2707 is removed from the top-edge feature-centroid-data set, shown in FIG. 27, and the least-squares method is repeated on the remaining top-edge-feature centroids located within tolerance bounds 2705 and 2706 to give least-squares line 2801, shown in FIG. 28. Note that least-squares line 2801 provides a closer approximation to the central trend of the top-edge-feature centroids.

FIG. 29 illustrates the least-squares lines fit to the edge-feature centroids, shown in FIG. 26, determined as described above with reference to FIGS. 27-28. In FIG. 29, lines 2901-2904 identify the least-squares lines fit to the edge feature centroids. For example, least-squares line 2901 is the least-squares line fit to top-edge-feature centroids. Least-squares-line intersections 2905-2908 identify the four corners of the feature-coordinate grid.

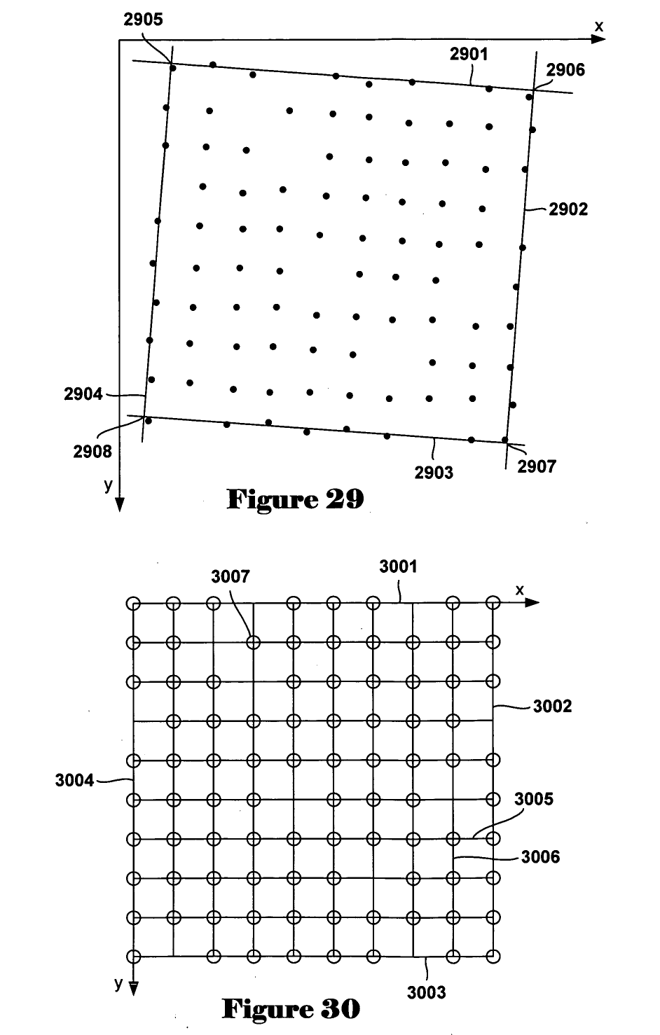

After the coordinates of the four comers are determined, a feature-coordinate grid is superimposed on the grid of features in the microarray. FIG. 30 illustrates an regularly spaced, feature-coordinate grid superimposed on the features shown in FIG. 25. Grid lines 3001-3004 correspond to the least-squares lines 2901-2904, respectively, shown in FIG. 29. A set of horizontal and vertical grid lines, such as horizontal grid line 3005 and vertical grid line 3006, are superimposed on the microarray image so that the vertical and horizontal grid line intersections coincide as closely as possible with the centers of microarray features to give a regularly spaced feature-coordinate grid. The feature-coordinate grid establishes a two-dimensional system for specifying the coordinate-based location of each feature. Thus, for example, using the horizontal grid line 3001 as the x-feature-coordinate axis and vertical grid line 3004 as the y-feature-coordinate axis, the approximate location of feature 3007 can be specified by the feature-coordinate grid coordinates (4, 2).

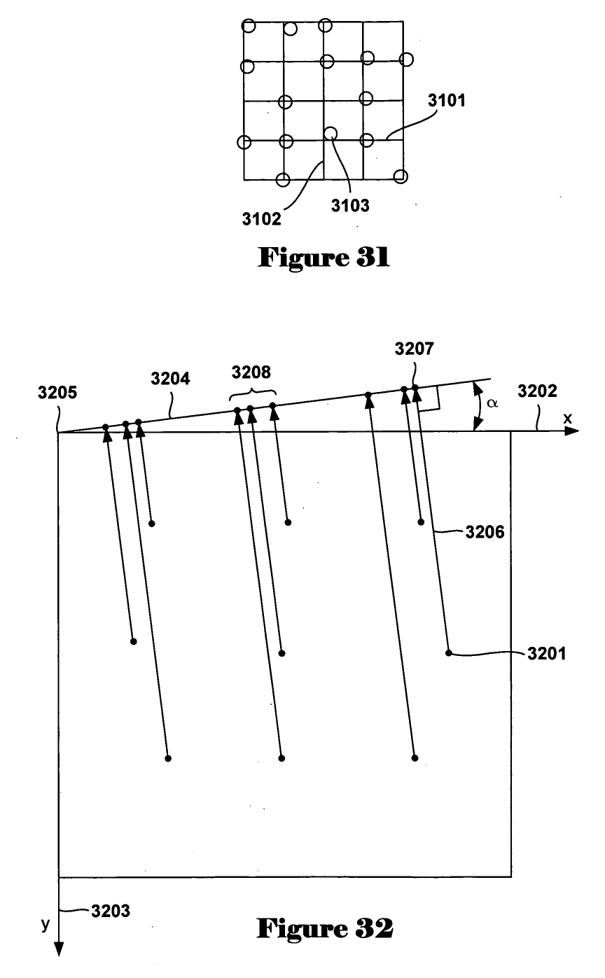

Determining the feature-coordinate grid, as described above with reference to FIG. 30, provides an initial rectilinear feature-coordinate grid, because many features of a microarray typically are located relatively close to the intersections of the initial regularly spaced feature-coordinate-grid lines, but do not exactly correspond to the horizontal and vertical grid line intersections. The failure of features to form straight evenly spaced rows and columns of features may be the result of misalignment with the feature depositing jets. FIG. 31 illustrates a portion of a microarray and an initial superimposed rectilinear feature-coordinate grid having features that do not coincide exactly with the horizontal and vertical grid line intersections. In FIG. 31, horizontal and vertical grid lines, such as horizontal grid line 3101 and vertical grid line 3102, are evenly spaced grid lines that have been superimposed on the microarray image, as described above with reference to FIG. 30. Feature 3103 identifies a feature that is not located at the intersection of horizontal grid line 3101 and vertical grid line 3102. Thus, after the initial rectilinear feature-coordinate grid is superimposed, an additional method is needed to further refine the initial feature-coordinate grid so that intersections of the horizontal and vertical grid lines coincide as closely as possible to feature centers. Information regarding refining a feature-coordinate grid is described in detail in Agilent U.S. Patent No.: 6,591,196, entitled “Method and System for Extracting Data from Surface Array Deposited Features,” filed Jun. 6, 2000, which is incorporated by reference.

After the feature-coordinate grid has been determined for each channel, as described above with reference to FIGS. 8-31, in one of many possible embodiments, a feature-coordinate grid can be established for all channels by averaging the location of each horizontal and vertical grid over number of channels. In alternate embodiments, the feature grid for a single channel can be used as the feature coordinate grid for all channels.

In an alternate embodiment, the feature-coordinate grid shown in FIG. 30 can be determined by projecting the feature centroids onto a line as a function of an angle α. FIG. 32 illustrates an initial step in the determination of the vertical grid lines of a feature-coordinate grid, as described above with reference to FIG. 30. In FIG. 32, nine feature centroids are identified by points, such as point 3201, horizontal x axis 3202 and vertical y axis 3203 identify the pixel coordinate axes in pixel units. Projection line 3204 is fixed at one end to the pixel-coordinate origin 3205. The feature centroids are projected onto projection line 3204 along vectors that are perpendicular to projection line 3204 to give clusters of densely packed points. For example, feature centroid 3201 is projected along perpendicular vector 3206 to give point 3207 located on projection line 3204. The projected points located along projection line 3204 are clustered, such as cluster of points 3208. Multiple projections for various values of angle α are used to determine the optimum angle α. The optimum angle α coincides with the projection line having the most densely packed clusters of points. The projection line corresponding to the optimum angle α represents the first feature-coordinate grid axis. Vertical feature-coordinate grid lines are determined by extending a line perpendicular to the projection line that emanates from the mean or median of each cluster of densely packed points. A second feature-coordinate grid axis can be determined independently in an identical manner, or by extending a line from the origin 3205 that is located at 90 degrees from the projection line 3204.

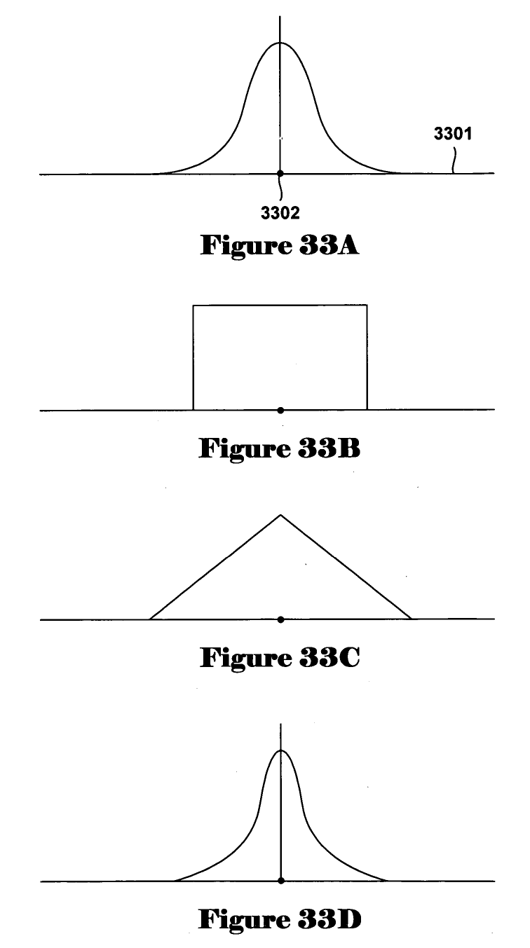

In an alternate embodiment, symmetric response functions are centered at each feature centroid and projected onto the projection line. FIG. 33 illustrates four of many different kinds of symmetric response functions centered about feature centroids. In FIGS. 33A-D, horizontal axes, such as horizontal axis 3301, are the coordinate axes for each response function. FIG. 33A-D illustrate a normal distribution function, a top-hat function, a saw-tooth function, and a Lorentzian function, respectively, where each response function is centered about a centroid, such as centroid 3302.

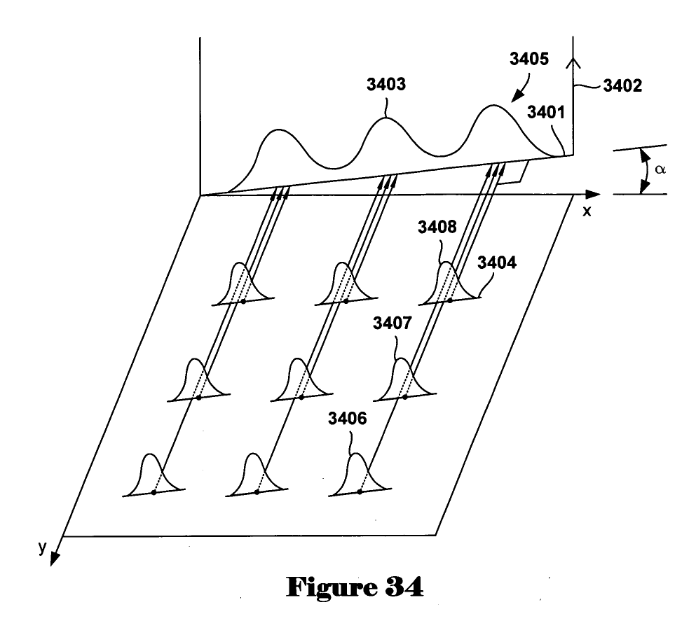

FIG. 34 illustrates a perspective view of employing normalized distribution functions centered at feature centroids of a microarray to determine the vertical grid lines. In FIG. 34, a normal distribution function is centered on each feature centroid and projected onto projection line 3401. The projected normal distribution function values are summed to give a vertical projection. The vertical projection is illustrated as a two-dimensional graph, where the total projected function values are plotted in the vertical direction 3402 along the horizontal projection line 3401. Projection of the normal distribution function values produces a wave-like graph 3403. Note that the orientation of the coordinate axis associated with each normal distribution function is parallel to the projection line 3401. For example, coordinate axis 3404 is parallel to projection line 3401. Note also that the wave-like graph 3403 is the result of summing the normal distribution functions centered on feature centroids. For example, the area under peak 3405 is equal to the sum total of the areas under normal distribution functions 3406-3408.

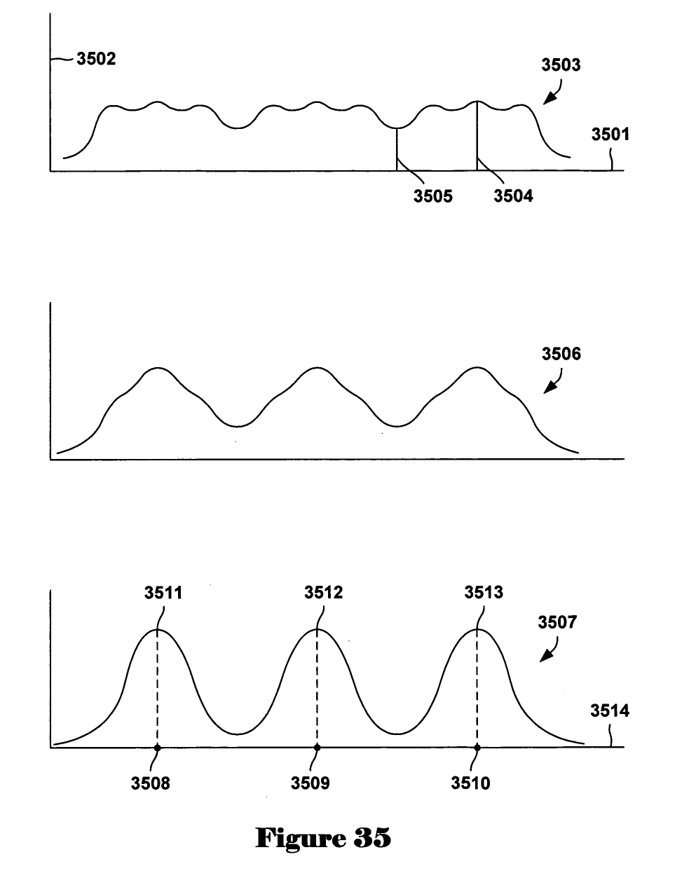

For each angle α, the contrast is used to determine the optimum angle α. The contrast is the ratio of the mean (or median) peak values to the mean (or median) trough values of a vertical projection. The largest contrast value corresponds to the optimum angle α. FIG. 35 illustrates determination of the optimum angle α based on three vertical projections of normal distribution functions. In FIG. 35, horizontal axes, such as horizontal axis 3501, represent the projection line, and vertical axes, such as vertical axis 3502, correspond to the vertical projection, as described above with reference to FIG. 34. The contrast for vertical projection 3503 is determined by computing the mean peak values, such as peak value 3504, to the mean trough values, such as trough value 3505. By comparing the contrast values for vertical projections 3504-3507, vertical projection 3507 gives the largest contrast value. The location of the vertical feature-coordinate grid lines can be determined by locating the points corresponding to maximum vertical projection values. For example, points 3508-3510 correspond to maximums 3511-3513 and can be used to locate vertical feature-coordinate grid lines extending perpendicular to projection line 3514.

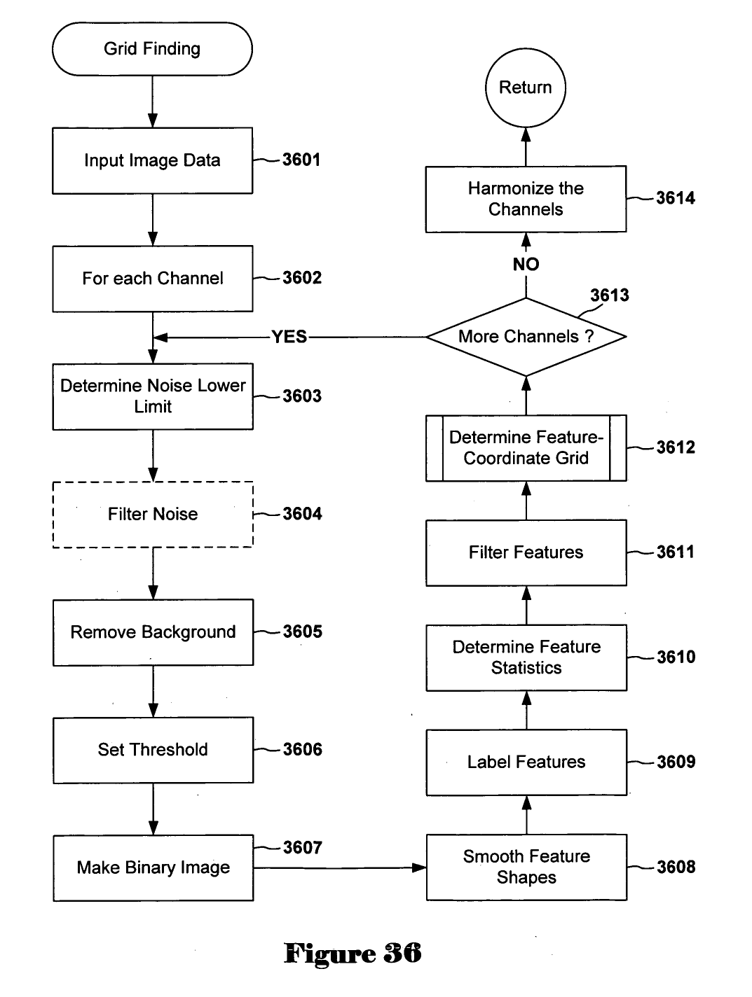

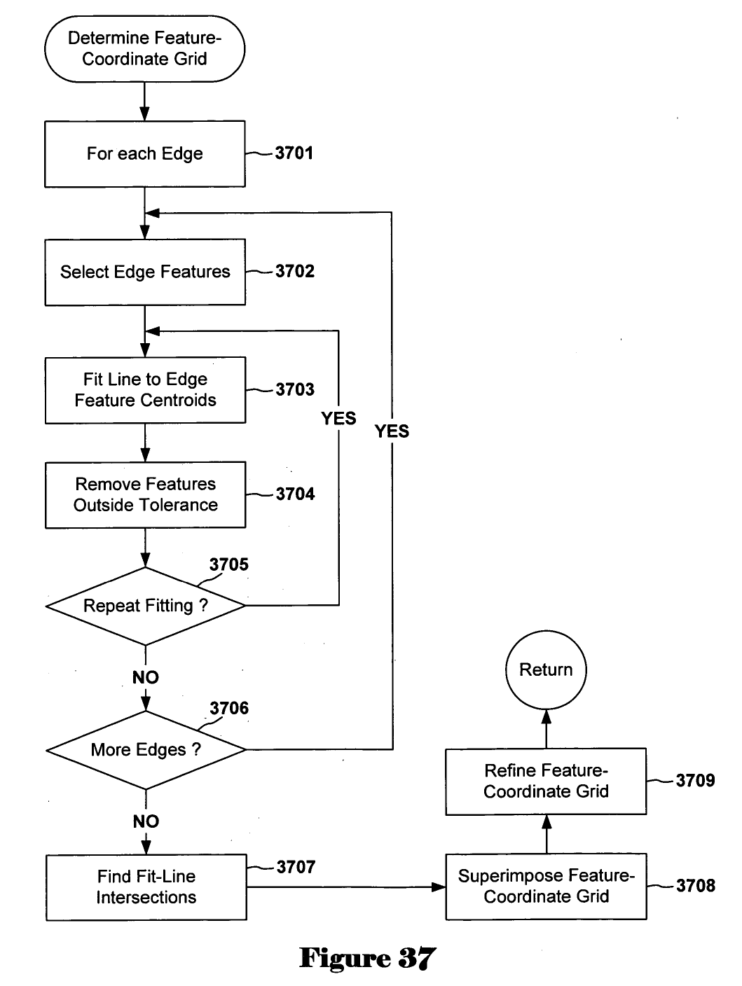

FIGS. 36-37 provide control-flow diagrams that describe one of many possible embodiments for determining a feature-coordinate grid, as described above with reference to FIGS. 8-31. FIG. 36 is a control-flow diagram for the routine “Grid Finding.” In step 3601, the input is composed of microarray image data, as described above with reference to FIGS. 12-14. In for-loop of step 3602, steps 3603-3614 are repeated for each channel of the microarray image. In step 3603, the noise value is determined. In optional step 3604, the noise is filtered, as described above with reference to FIGS. 15-17. In step 3605, the background signal is removed, as described above with reference to FIG. 18. In step 3606, a value for the threshold TV is determined. In step 3607, a binary-microarray image of the microarray channel is generated, as described above with reference to FIGS. 19-20. In step 3608, the form of each feature in the binary-microarray image is smoothed, as described above with reference to FIGS. 21-22. In step 3609, the contiguous pixels composing each feature are labeled, as described above with reference to FIG. 23. In step 3610, feature statistics, such as feature area, centroid, x-extent and y-extent, and the eccentricity are determined, as described above with reference to FIG. 24. In step 3611, the features are filtered. In step 3612, the routine “Determine Feature-Coordinate Grid” is called. In step 3613, if more channels are available, then steps 3603-3613 are repeated. In step 3614, the feature-coordinate-grid lines can be harmonized by averaging the location of horizontal and vertical grid lines over the number of channels.

FIG. 37 illustrates the routine “Determine Feature-Coordinate Grid.” In for-loop of step 3701, steps 3702-3706 are repeated. In step 3702, edge feature centroids are selected, as described above with reference to FIG. 26. In step 3703, lines are fit to the edge feature centroids, as described above with reference to FIGS. 27-28. In step 3704, feature centroids outside the tolerance range are removed. In step 3705, the line fitting in steps 3703 and 3704 is repeated after feature centroids located outside the tolerance range have been removed. In step 3706, if a line has been fit to each edge, then control passes to step 3707, otherwise steps 3702-3705 are repeated. In step 3707, the intersections of the fit lines are determined. In step 3708, a feature-coordinate grid is superimposed on the microarray image, as described above with reference to FIG. 30. In step 3709, the feature-coordinate is further refined, as described above with reference to FIG. 31.

Although the present invention has been described in terms of a particular embodiment, it is not intended that the invention be limited to this embodiment. Modifications within the spirit of the invention will be apparent to those skilled in the art. For example, an almost limitless number of different implementations of the many possible embodiments of the method of the present invention can be written in any of many different programming languages, embodied in firmware, embodied in hardware circuitry, or embodied in a combination of one or more of the firmware, hardware, or software, for inclusion in microarray data processing equipment employing a computational processing engine to execute software or firmware instructions encoding techniques of the present invention or including logic circuits that embody both a processing engine and instructions. In an alternate embodiment, the kernel may be any geometric shape, such as a circle, a rectangle, a pentagon, or a hexagon centered about a pixel. In alternate embodiments, the methods of the present invention can be employed to determine a feature-coordinate grid for each subgrid of a microarray, such as the subgrid displayed in FIG. 14. In an alternate embodiment, a two-dimensional Fourier Transform and a high band pass filter in the frequency domain can be used to filter noise and pixels having excessive high pixel-intensity values.

The foregoing description, for purposes of explanation, used specific nomenclature to provide a thorough understanding of the invention. However, it will be apparent to one skilled in the art that the specific details are not required in order to practice the invention. The foregoing description of specific embodiments of the present invention are presented for purposes of illustration and description. They are not intended to be exhaustive or to limit the invention to the precise forms disclosed. Obviously many modifications and variations are possible in view of the above teachings. The embodiments are shown and described in order to best explain the of the invention and its practical applications, to thereby enable others skilled in the art to best utilize the invention and various embodiments with various modifications as are suited to the particular use contemplated. It is intended that the scope of the invention be defined by the following claims and their equivalents:

What is claimed is:

1. A method for determining a feature-coordinate grid for a microarray image, the method comprising:
receiving a microarray-image-data set;
determining centroid coordinates for each feature of the microarray image;
fitting a line to the centroid coordinates of features located along each edge of the microarray image;
determining intersection coordinates of the fitted lines; and
superimposing horizontal grid lines and vertical grid lines having intersections that coincide with features of the microarray image, based on the intersection coordinates of the fitted lines.

2. The method of claim 1 further including:
optionally filtering noise and pixels having high pixel-intensity values from the microarray-image-data set; and
removing background signal from the microarray-image-data set.

3. The method of claim 2 wherein optionally filtering noise and pixels having high pixel-intensity values further includes:
employing a filter that operates on a neighborhood of pixels surrounding a central pixel;
moving the central pixel from pixel to pixel; and
applying the filter to the pixels within the neighborhood for each pixel.

4. The method of claim 2 wherein removing the background signal further includes:
employing a filter that operates on a neighborhood of pixels surrounding a central pixel;
moving the central pixel from pixel to pixel;
applying the filter to a sample of pixels within the neighborhood for each pixel; and
subtracting the filtered signal value from pixel-intensity values having identical pixel coordinates for each pixel.

5. The method of claim 1 further including:
determining a threshold value, based on a lower limit of the microarray-image-data-set noise; and
determining a binary-microarray image of the microarray image, based on the threshold value.

6. The method of claim 5 wherein determining the binary-microarray image further includes assigning an identical first numerical value to all pixels having a pixel-intensity value less than the threshold value; and assigning an identical second numerical value to all pixels having a pixel-intensity value greater than the threshold value.

7. The method of claim 5 further includes:
smoothing each feature of the binary-microarray image; and
labeling pixels having contiguous edges with unique numerical labels.

8. The method of claim 5 wherein filtering the binary-microarray image further includes:
removing features having an area in pixel coordinates outside feature area boundaries;
removing features having an eccentricity value less than about 2; and
removing features having a fill factor value greater than about 0.5.

9. The method of claim 1 wherein fitting a line to the centroid coordinates along each edge further includes
discarding centroids outside the fitted line error bounds; and
fitting a line to the remaining centroid coordinates of features located along each edge of the microarray image.

10. The method of claim 1 wherein superimpose horizontal grid lines and vertical grid lines further includes refining the location of horizontal grid line and vertical grid line intersections to coincide with the center of each feature.

11. A method for determining a feature-coordinate grid for a microarray image, the method comprising:
receiving microarray-image data;
determining centroid coordinates for each feature of the microarray image;
projecting each centroid onto a first projection line that extends from the pixel coordinate origin at a first angle to a first pixel-coordinate axis to give a distribution of densely packed points and sparsely packed points along the first projection line;
optimizing the first angle between the first projection line and the pixel-coordinate axis, based on the contrast between the one or more clusters of densely packed points and sparsely packed points along the projection line; and
superimposing grid lines on the microarray image that extend perpendicular to the first projection line and emanate from the centers of the one or more clusters of densely packed points.

12. The method of claim 11 further including:
optionally filtering noise and pixels having high pixel-intensity values from the microarray-image-data set; and
removing background signal from the microarray-image-data set.

13. The method of claim 12 wherein optionally filtering noise and pixels having high pixel-intensity values further includes:
employing a filter that operates on a neighborhood of pixels surrounding a central pixel;
moving the central pixel from pixel to pixel; and
applying the filter to the pixels within the neighborhood for each pixel.

14. The method of claim 12 wherein removing the background signal further includes:
employing a filter that operates on a neighborhood of pixels surrounding a central pixel;
moving the central pixel from pixel to pixel;
applying the filter to a sample of pixels within the neighborhood for each pixel; and
subtracting the filtered signal value from pixel-intensity values having identical pixel coordinates for each pixel.

15. The method of claim 11 further including:
determining a threshold value, based on the microarray image;
determining a binary-microarray image of the microarray image, based on the threshold value; and
filtering the binary-microarray image.

16. The method of claim 15 wherein determining the binary-microarray image further includes assigning an identical first numerical value to all pixels having a pixel-intensity value less than the threshold value; and assigning an identical second numerical value to all pixels having a pixel-intensity value greater than the threshold value.

17. The method of claim 15 further includes:
smoothing each feature of the binary-microarray image; and
labeling pixels having contiguous edges with identical numerical labels.

18. The method of claim 15 wherein filtering the binary-microarray image further includes:
removing features having an area in pixel coordinates outside feature area boundaries;
removing features having an eccentricity value less than about 2; and
removing features having a fill factor value greater than about 0.5.

19. The method of claim 11 wherein projecting each centroid onto the first projection line further includes projecting along vectors perpendicular to the first projection line.

20. The method of claim 11 wherein optimizing the first angle further includes
performing one or more projections onto the first projection line for one or more first angles; and
selecting the optimum angle based on the corresponding projection line having the greatest contrast between densely pack points and sparsely packed points.

21. The method of claim 11 further includes determining the center of densely packed points by determining the mean value of each cluster of densely packed points located along the first projection line.

22. The method of claim 11 further includes determining the center of densely packed points by determining the median value of each cluster of densely packed points located along the first projection line.

23. The method of claim 11 further includes:
centering resource functions on each centroid; and
projecting each resource function to obtain a vertical projection.

24. The method of claim 11 further includes repeating the method of claim 11 for a second projection line extending from the pixel-coordinate origin at a second angle to a second pixel-coordinate axis.

25. Transferring results produced by a microarray reader or microarray data processing program employing the method of claim 1 stored in a computer-readable medium to an intercommunicating entity.

26. Transferring results produced by a microarray reader or microarray data processing program employing the method of claim 1 to an intercommunicating entity via electronic signals.

27. A computer program including an implementation of the method of claim 1 stored in a computer-readable medium.

28. A method comprising forwarding data produced by employing the method of claim 1 to a remote location.

29. A method comprising receiving data produced by employing the method of claim 1 from a remote location.

30. A microarray reader that employs the method of claim 1 to determine a feature-coordinate grid for a microarray image.

31. A system for determining a feature-coordinate grid for a microarray image, the system comprising:
a computer processor;
a communications medium by which microarray data are received by the molecular-array-data processing system;
a program, stored in the one or more memory components and executed by the computer processor receives a microarray-image data, determines centroid coordinates for each feature of the microarray image, fits a line to the centroid coordinates of features located along each edge of the microarray image, determines intersection coordinates of the fitted lines, and superimposes horizontal grid lines and vertical grid lines having intersections that coincide with features of the microarray image, based on the intersection coordinates of the fitted lines.
